(19) United States
(12) Patent Application Publication
(10) Pub. No.: US 2022/0215227 A1
(43) Pub. Date: Jul. 7, 2022

(54) Neural Architecture Search Method, Image Processing Method And Apparatus, And Storage Medium

(71) Applicant: HUAWEI TECHNOLOGIES CO., LTD., Shenzhen (CN)

(72) Inventors: Guilin LI, Shenzhen (CN); Zhenguo LI, Hong Kong (CN); Xing ZHANG, Shenzhen (CN)

(21) Appl. No.: 17/704,551

(22) Filed: Mar. 25, 2022

Related U.S. Application Data
(63) Continuation of application No. PCT/CN2020/092210, filed on May 26, 2020.

(30) Foreign Application Priority Data
Sep. 25, 2019 (CN) 201910913248.X

(51) Int. Cl. G06N 3/04; G06N 3/063

(52) U.S. Cl. CPC G06N 3/04; G06N 3/063

(57) ABSTRACT

This application provides a neural architecture search method, an image processing method and apparatus, and a storage medium. The method includes: determining a search space and a plurality of structuring elements, stacking the plurality of structuring elements to obtain an initial neural architecture at a first stage, and optimizing the initial neural architecture at the first stage to be convergent; and after an initial neural architecture optimized at the first stage is obtained, optimizing the initial neural architecture at a second stage to be convergent, to obtain optimized structuring elements, and building a target neural network based on the optimized structuring elements. Each edge of the initial neural architecture at the first stage and each edge of the initial neural architecture at the second stage correspond to a mixed operator including one type of operations and a mixed operator including a plurality of types of operations respectively.

### CROSS-REFERENCE TO RELATED APPLICATIONS

This application is a continuation of International Application No. PCT/CN2020/092210, filed on May 26, 2020, which claims priority to Chinese Patent Application No. 201910913248.X, filed on Sep. 2019. The disclosures of the aforementioned applications are hereby incorporated by reference in their entireties.

### TECHNICAL FIELD

This application relates to the field of artificial intelligence, and more specifically, to a neural architecture search method, an image processing method and apparatus, and a storage medium.

### BACKGROUND

Artificial intelligence (artificial intelligence, AI) is a theory, a method, a technology, or an application system that simulates, extends, and expands human intelligence by using a digital computer or a machine controlled by a digital computer, to perceive an environment, obtain knowledge, and achieve an optimal result by using the knowledge. In other words, artificial intelligence is a branch of computer science, and is intended to understand essence of intelligence and produce a new intelligent machine that can react in a manner similar to human intelligence. Artificial intelligence is to study design principles and implementation methods of various intelligent machines, so that the machines have perceiving, inference, and decision-making functions. Researches in an artificial intelligence field include a robot, natural language processing, computer vision, decision-making and inference, human-computer interaction, recommendation and search, an AI basic theory, and the like.

With rapid development of artificial intelligence technologies, a neural network (for example, a deep neural network) has scored great achievements in processing and analyzing a plurality of media signals such as an image, a video, and voice. A neural network with excellent performance often has a delicate network architecture that requires a lot of effort to be established by highly skilled and experienced human experts. To better establish a neural network, a neural architecture search (neural architecture search, NAS) method is proposed to establish a neural network, and a neural architecture with excellent performance is obtained by automatically searching a neural architecture. Therefore, how to obtain a neural architecture with relatively good performance through neural architecture search is important.

### SUMMARY

This application provides a neural architecture search method, an image processing method and apparatus, and a storage medium, to search and obtain a neural architecture with better performance.

According to a first aspect, a neural architecture search method is provided. The method includes: determining a search space and a plurality of structuring elements; stacking the plurality of structuring elements to obtain an initial neural architecture at a first stage; optimizing the initial neural architecture at the first stage to be convergent, to obtain an optimized initial neural architecture at the first stage; obtaining the initial neural architecture at a second stage, and optimizing the initial neural architecture at the second stage to be convergent, to obtain optimized structuring elements, and building a target neural network based on the optimized structuring elements.

The search space includes a plurality of groups of alternative operators, each group of alternative operators includes at least one operator, and types of operators in each group of alternative operators are the same (that is, the at least one operator in each group of operators is of a same type).

Each of the plurality of structuring elements is a network structure that is between a plurality of nodes and that is obtained by connecting basic operators of a neural network, and the nodes of each of the plurality of structuring elements are connected to form an edge.

Structures of the initial neural architecture at the first stage and the initial neural architecture at the second stage are the same. Specifically, types and a quantity of the structuring elements in the initial neural architecture at the first stage are the same as types and a quantity of structuring elements in the initial neural architecture at the second stage. In addition, a structure of an structuring element in the initial neural architecture at the first stage is exactly the same as a structure of an i^{th} structuring element in the initial neural architecture at the second stage, where i is a positive integer.

A difference between the initial neural architecture at the first stage and the initial neural architecture at the second stage is that alternative operators corresponding to corresponding edges in corresponding structuring elements are different.

Specifically, each edge of each structuring element in the initial neural architecture at the first stage corresponds to a plurality of alternative operators, and each of the plurality of alternative operators corresponds to one group in the plurality of groups of alternative operators.

Optionally, the search space is formed by M groups of alternative operators (that is, the search space includes M groups of alternative operators in total). Each edge of each structuring element in the initial neural architecture at the first stage corresponds to M alternative operators, and the NI alternative operators separately come from M groups of alternative operators in the search space.

In other words, one alternative operator is selected from each of the M groups of alternative operators, to obtain the M alternative operators. M is an integer greater than 1.

For example, the search space includes four groups of alternative operators in total, and then each edge of each structuring element in the initial neural architecture at the first stage may correspond to four alternative operators. The four alternative operators separately come from the four groups of alternative operators (where one alternative operator is selected from each group of alternative operators, to obtain the four alternative operators).

A mixed operator corresponding to a j^{th} edge of an i^{th} structuring element in the initial neural architecture at the second stage includes all operators in a k^{th} group of alternative operators in the optimized initial neural architecture at the first stage, the k^{th} group of alternative operators is a group of alternative operators including an operator with a largest weight in a plurality of alternative operators corresponding to the j^{th} edge of the i^{th} structuring element in the optimized initial neural architecture at the first stage, and i, j, and k are all positive integers.

The optimized structuring elements may be referred to as optimal structuring elements, and the optimized structuring elements are used to build or stack a required target neural network.

In this application, in a process of neural architecture search, which type of alternative operators should be used for each edge of each structuring element is determined at the first stage in the optimization process, and which specific alternative operator should be used for each edge of each structuring element is determined at the second stage in the optimization process, so that a problem of multicollinearity can be avoided, and a target neural network with better performance can be built based on an optimized structuring element.

With reference to the first aspect, in some implementations of the first aspect, the plurality of groups of alternative operators include:

a first group of alternative operators, including 3×3 max pooling and 3×3 average pooling;

a second group of alternative operators, including a skip connection;

a third group of alternative operators, including 3×3 separable convolutions and 5×5 separable convolutions; and

a fourth group of alternative operators, including 3×3 dilated separable convolutions and 5×5 dilated separable convolutions.

For example, for the initial neural architecture at the first stage, a plurality of alternative operators corresponding to each edge of each structuring element may include 3×3 max pooling, a skip connection, 3×3 separable convolutions, and 3×3 dilated separable convolutions.

For another example, for the optimized initial neural architecture at the first stage, an operator with a largest weight on a j^{th} edge of an i^{th} structuring element is 3×3 max pooling. Then, for the optimized initial neural architecture at the second stage, an alternative operator corresponding to the j^{th} edge of the i^{th} structuring element is a mixed operator including 3×3 max pooling and 3×3 average pooling.

In addition, in a process of optimizing the initial neural architecture at the second stage, respective weights of 3×3 max pooling and 3×3 average pooling on the j^{th} edge of the i^{th} structuring element in the initial neural architecture at the second stage are determined, and then an operator with a largest weight is selected as an operator on the j^{th} edge of the i^{th} structuring element.

With reference to the first aspect, in some implementations of the first aspect, the method further includes: performing clustering on a plurality of alternative operators in the search space, to obtain the plurality of groups of alternative operators.

The clustering on a plurality of alternative operators in the search space may be classifying the plurality of alternative operators in the search space into different types, and each type of alternative operators form one group of alternative operators.

Optionally, the performing clustering on a plurality of alternative operators in the search space, to obtain the plurality of groups of alternative operators includes: performing clustering on the plurality of alternative operators in the search space, to obtain correlation between the plurality of alternative operators in the search space; and grouping the plurality of alternative operators in the search space based on the correlation between the plurality of alternative operators in the search space, to obtain the plurality of groups of alternative operators.

The correlation may be linear correlation, where the linear correlation may be represented as a degree of linear correlation (which may be a value from 0 to 1), and a higher value of a degree of linear correlation between two alternative operators indicates a closer relationship between the two alternative operators.

For example, through clustering analysis, a degree of linear correlation between 3×3 max pooling and 3×3 average pooling is 0.9. Then, correlation between 3×3 max pooling and 3×3 average pooling can be considered as relatively high, and 3×3 max pooling and 3×3 average pooling may be classified into one group.

Through clustering, the plurality of alternative operators in the search space can be classified into the plurality of groups of alternative operators, thereby facilitating subsequent optimization in a process of neural network search.

With reference to the first aspect, in some implementations of the first aspect, the method further includes: selecting one operator from each of the plurality of groups of alternative operators, to obtain the plurality of alternative operators corresponding to each edge of each structuring element in the initial neural architecture at the first stage.

With reference to the first aspect, in some implementations of the first aspect, the method further includes: determining an operator with a largest weight on each edge of each structuring element in the initial neural architecture at the first stage; and determining a mixed operator including all alternative operators in a group of alternative operators in which there is an operator with a largest weight on a j^{th} edge of an i^{th} structuring element in the initial neural architecture at the first stage as alternative operators corresponding to the j^{th} edge of the i^{th} structuring element in the initial neural architecture at the second stage.

With reference to the first aspect, in some implementations of the first aspect, the optimizing the initial neural architecture at the first stage to be convergent, to obtain optimized structuring elements includes: separately optimizing, by using same training data, a network architecture parameter and a network model parameter that are of a structuring element in the initial neural architecture at the first stage to be convergent, to obtain the optimized initial neural architecture at the first stage; and/or the optimizing the initial neural architecture at the second stage to be convergent, to obtain optimized structuring elements includes: separately optimizing, by using same training data, a network architecture parameter and a network model parameter that are of a structuring element in the initial neural architecture at the second stage to be convergent, to obtain the optimized structuring elements.

A network architecture parameter and a network model parameter are optimized by using same training data. Compared with conventional two-layer optimization, a neural network with better performance can be obtained through searching with a same amount of training data.

According to a second aspect, a neural architecture search method is provided. The method includes: determining a search space and a plurality of structuring elements; stacking the plurality of structuring elements to obtain a search network; separately optimizing, in the search space by using same training data, a network architecture parameter and a network model parameter that are of the structuring elements in the search network, to obtain optimized structuring elements; and building a target neural network based on the optimized structuring elements.

Each of the plurality of structuring elements is a network structure that is between a plurality of nodes and that is obtained by connecting basic operators of a neural network.

In this application, a network architecture parameter and a network model parameter are optimized by using same training data. Compared with conventional two-layer optimization, a neural network with better performance can be obtained through searching with a same amount of training data.

With reference to the second aspect, in some implementations of the second aspect, the separately optimizing, in the search space by using same training data, a network architecture parameter and a network model parameter that are of the structuring elements in the search network, to obtain optimized structuring elements includes:

determining an optimized network architecture parameter and an optimized network model parameter of the structuring elements in the search network based on same training data and by using formulas.

$${α}_{t} = {α}_{t - 1} - {η}_{t} * {\partial }_{α} {L}_{train} ( {w}_{t - 1 ,} {α}_{t - 1} ) ; and$$

$${w}_{t} = {w}_{t - 1} - {δ}_{t} * {\partial }_{w} {L}_{train} ( {w}_{t - 1 ,} {α}_{t - 1} )$$

αₜ and wₜ respectively represent a network architecture parameter and a network model parameter that are optimized at a t^{th} step performed on the structuring elements in the search network; αₜ₋₁ and wₜ₋₁ respectively represent a network architecture parameter and a network model parameter that are optimized at a (t−1)^{th} step performed on the structuring elements in the search network; ηₜ and δₜ respectively represent learning rates of the network architecture parameter and the network model parameter that are optimized at the t^{th} step performed on the structuring elements in the search network; Lₜᵣₐᵢₙ(wₜ₋₁,αₜ₋₁) represents a value of a loss function of a test set during optimization at the t^{th} step; ∂_{α}Lₜᵣₐᵢₙ(wₜ₋₁,αₜ₋₁) represents a gradient for eα of the loss function in the test set during optimization at the t^{th} step; and ∂_{w}Lₜᵣₐᵢₙ(wₜ₋₁,αₜ₋₁) represents a gradient for w of the loss function in the test set during optimization at the t^{th} step.

In addition, the network architecture parameter a represents a weight coefficient of each operator, and a value of a indicates importance of the corresponding operator; and w represents a set of all other parameters in the architecture, including a parameter in convolution, a parameter at a prediction layer, and the like.

According to a third aspect, an image processing method is provided. The method includes: obtaining a to-be-processed image; and processing the to-be-processed image based on a target neural network, to obtain a processing result of the to-be-processed image.

The target neural network in the third aspect is a neural network structured according to any implementation in the first aspect or the second aspect.

Because a target neural network with better performance can be structured by using the neural architecture search method in the first aspect, in the third aspect, when the target neural network is used to process the to-be-processed image, a more accurate image processing result can be obtained,

Processing the to-be-processed image may mean recognizing, classifying, detecting the to-be-processed image, and the like.

According to a fourth aspect, an image processing method is provided. The method includes: obtaining a to-be-processed image; and processing the to-be-processed image based on a target neural network, to obtain a classification result of the to-be-processed image.

The target neural network in the fourth aspect is a target neural network structured according to any implementation in the first aspect or the second aspect.

According to a fifth aspect, an image processing method is provided. The method includes: obtaining a road picture; performing convolution processing on the road picture based on a target neural network, to obtain a plurality of convolutional feature maps of the road picture; and performing deconvolution processing on the plurality of convolutional feature maps of the road picture based on the target neural network, to obtain a semantic segmentation result of the road picture.

The target neural network in the fifth aspect is a target neural network structured according to any implementation in the first aspect or the second aspect.

According to a sixth aspect, an image processing method is provided. The method includes: obtaining a face image; performing convolution processing on the face image based on a target neural network, to obtain a convolutional feature map of the face image; and comparing the convolutional feature map of the face image with a convolutional feature map of an identification card image, to obtain a verification result of the face image.

The convolutional feature map of the identification card image may be obtained in advance and stored in a corresponding database. For example, convolution processing is performed on the identification card image in advance, and the obtained convolutional feature map is stored in the database.

In addition, the target neural network in the sixth aspect is a target neural network structured according to any implementation in the first aspect or the second aspect.

According to a seventh aspect, a neural architecture search apparatus is provided. The apparatus includes: a memory, configured to store a program; and a processor, configured to execute the program stored in the memory, where when executing the program stored in the memory, the processor is configured to perform the method in any one of the implementations of the first aspect or the second aspect.

According to an eighth aspect, an image processing apparatus is provided. The apparatus includes: a memory, configured to store a program; and a processor, configured to execute the program stored in the memory, where when executing the program stored in the memory, the processor is configured to perform the method in any one of the implementations of the third aspect to the sixth aspect.

According to a ninth aspect, a computer-readable medium is provided. The computer-readable medium stores program code used by a device for execution, and the program code is used by the device to perform the method in any one of the implementations of the first aspect to the sixth aspect.

According to a tenth aspect, a computer program product including instructions is provided. When the computer program product is run on a computer, the computer is enabled to perform the method in any one of the implementations of the first aspect to the sixth aspect.

According to an eleventh aspect, a chip is provided. The chip includes a processor and a data interface, and the processor reads, through the data interface, instructions stored in a memory, to perform the method in any one of the implementations of the first aspect to the sixth aspect.

Optionally, in an implementation, the chip may further include the memory and the memory stores the instructions. The processor is configured to execute the instructions stored in the memory, and when the instructions are executed, the processor is configured to perform the method in any one of the implementations of the first aspect to the sixth aspect.

### BRIEF DESCRIPTION OF DRAWINGS

FIG. 1 is a schematic diagram of a specific application according to an embodiment of this application;

FIG. 2 is a schematic diagram of a structure of a system architecture according to an embodiment of this application;

FIG. 3 is a schematic diagram of a structure of a convolutional neural network according to an embodiment of this application;

FIG. 4 is a schematic diagram of a structure of a convolutional neural network according to an embodiment of this application;

FIG. 5 is a schematic diagram of a hardware structure of a chip according to an embodiment of this application;

FIG. 6 is a schematic diagram of a system architecture according to an embodiment of this application; and

FIG. 7 is a schematic flowchart of a neural architecture search method according to an embodiment of this application;

FIG. 8 is a schematic diagram of a structure of a structuring element;

FIG. 9 is a schematic diagram of a structuring element in an initial neural architecture at a first stage;

FIG. 10 is a schematic diagram of a structuring element in an optimized initial neural architecture at a first stage;

FIG. 11 is a schematic diagram of a structuring element in an initial neural architecture at a second stage;

FIG. 12 is a schematic diagram of a structure of a search network;

FIG. 13 is a schematic flowchart of a neural architecture search method according to an embodiment of this application;

FIG. 14 is a schematic flowchart of a neural architecture search method according to an embodiment of this application;

FIG. 15 is a schematic flowchart of an image processing method according to an embodiment of this application;

FIG. 16 is a schematic block diagram of a neural architecture search apparatus according to an embodiment of this application;

FIG. 17 is a schematic block diagram of an image processing apparatus according to an embodiment of this application; and

FIG. 18 is a schematic block diagram of a neural network training apparatus according to an embodiment of this application.

### DESCRIPTION OF EMBODIMENTS

The following describes the technical solutions in this application with reference to the accompanying drawings.

The embodiments of this application may be applied to many fields of artificial intelligence, for example, fields such as smart manufacturing, smart transportation, smart home, smart health care, smart security protection, autonomous driving, and a safe city.

Specifically, the embodiments of this application may be applied to fields in which a (deep) neural network needs to be used, for example, image classification, image retrieval, image semantic segmentation, image super-resolution processing, and natural language processing.

In the scenario of image classification, in the embodiments of this application, a neural network (which is a neural network obtained through searching by using a neural architecture search method in the embodiments of this application) obtained through searching may be specifically applied to album image classification. The following describes in detail a case in which the embodiments of this application are applied to album image classification.

Album image classification:

Specifically, when a user stores a large quantity of images on a terminal device (for example, a mobile phone) or a cloud disk, recognition of images in an album may help the user or a system perform classification management on the album, thereby improving user experience.

A neural architecture suitable for album classification can be obtained through searching by using a neural architecture search method in this embodiment of this application, and then a neural network is trained based on a training image in a training image library, to obtain an album classification neural network. Then, the album classification neural network may be used to classify images, to label images of different categories, so as to facilitate viewing and searching by the user. In addition, after classification labels of these images are obtained, an album management system may further perform classified management based on the classification labels of these images, thereby reducing a time for management by a user, improving an album management efficiency, and improving user experience.

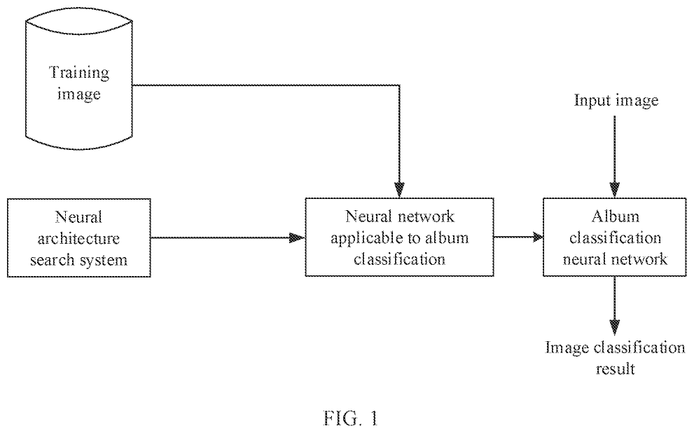

As shown in FIG. 1, a neural network suitable for album classification may be established by using a neural architecture search system (corresponding to the neural architecture search method in this embodiment of this application). After the neural network suitable for album classification is obtained, the neural network may be trained based on the training image, to obtain an album classification neural network. Then, the album classification neural network may be used to classify a to-be-processed image. For example, as shown in FIG. 1, the album classification neural network processes an input image, to obtain that a category of the image is a tulip.

In the embodiments of this application, in addition to being applied to album image classification, a neural network (which is a neural network obtained through searching by using a neural architecture search method in the embodiments of this application) obtained through searching may further be applied to a scenario of autonomous driving. Specifically, the neural network obtained through searching in the embodiments of this application can be applied to object recognition in the scenario of autonomous driving.

Object recognition in an autonomous driving scenario:

During autonomous driving, a large amount of sensor data needs to be processed, and a deep neural network plays a significant role in autonomous driving with powerful capabilities. The neural architecture search method in the embodiments of this application is used, and a neural network applicable to processing of image information in the scenario of autonomous driving can be structured. Then, the neural network is trained based on training data (which includes the image information and a label of the image information) in the scenario of autonomous driving, and a neural network used to process the image information in the scenario of autonomous driving can be obtained. Finally, the neural network can be used to process input image information, to recognize different objects in pictures of lanes.

Because the embodiments of this application relate to massive application of a neural network, for ease of understanding, the following describes terms and concepts related to the neural network that may be used in the embodiments of this application.

(1) Neural Network

The neural network may include a neural unit. The neural unit may be an operation unit that uses xₛ and an intercept 1 as input, and output of the operation unit may be shown in formula (1):

$${h}_{W , b} ( x ) = f ( {W}^{T} x ) = f ( {\sum }_{s = 1}^{n} {W}_{s} {x}_{s} + b ) \qquad ( 1 )$$

Herein, s=1, 2, . . . , n, n is a natural number greater than 1, Wₛ represents a weight of xₛ, b represents a bias of the neural unit, and f represents an activation function (activation function) of the neural unit, where the activation function is used to introduce a non-linear characteristic into the neural network, to convert an input signal in the neural unit into an output signal. The output signal of the activation function may be used as input of a next convolutional layer, and the activation function may be a sigmoid function. The neural network is a network constituted by connecting a plurality of single neural units together. To be specific, output of a neural unit may be input of another neural unit. Input of each neural unit may be connected to a local receptive field of a previous layer to extract a feature of the local receptive field. The local receptive field may be a region including several neural units.

(2) Deep Neural Network

The deep neural network (deep neural network, DNN) is also referred to as a multi-layer neural network, and may be understood as a neural network having a plurality of hidden layers. The DNN is divided based on positions of different layers. Neural networks inside the DNN may be classified into three types: an input layer, a hidden layer, and an output layer. Generally, a first layer is the input layer, a last layer is the output layer, and a middle layer is the hidden layer. Layers are fully connected. To be specific, any neuron in an i^{th} layer is necessarily connected to any neuron in an (i+1)^{th} layer.

Although the DNN seems complex, work of each layer is actually not complex, and is simply expressed by the following linear relational expression: \vec{y}=α(W·\vec{x}+\vec{b}). \vec{x} represents an input vector, \vec{y} represents an output vector, \vec{b} represents a bias vector, if represents a weight matrix (which is also referred to as a coefficient), and α( ) represents an activation function. In each layer, only such a simple operation is performed on the input vector \vec{x} to obtain the output vector \vec{y}. Due to a large quantity of DNN layers, quantities of coefficients W and bias vectors \vec{b} are also large. These parameters are defined in the DNN as follows: Using the coefficient IL as an example, it is assumed that in a three-layer DNN, a linear coefficient from a fourth neuron in a second layer to a second neuron in a third layer is defined as W₂₄³. A superscript 3 represents a number of a layer in which the coefficient W is located, and a subscript corresponds to an index 2 of the third layer for output and an index 4 of the second layer for input.

In conclusion, a coefficient from a k^{th} neuron in an (L−1)^{th} layer to a j^{th}neuron in an Lth layer is defined as Wⱼₖ^{L}.

It should be noted that the input layer has no parameter W In the deep neural network, more hidden layers make the network more capable of describing a complex case in the real world. Theoretically, a model with more parameters has higher complexity and a larger “capacity”. It indicates that the model can complete a more complex learning task. Training of the deep neural network is a process of learning a weight matrix, and a final objective of the training is to obtain a weight matrix of all layers of a trained deep neural network (a weight matrix formed by vectors W of many layers).

(3) Convolutional Neural Network

The convolutional neural network (convolutional neuron network, CNN) is a deep neural network with a convolutional structure. The convolutional neural network includes a feature extractor including a convolutional layer and a sub-sampling layer. The feature extractor may be considered as a filter. The convolutional layer is a neuron layer that performs convolution processing on an input signal that is in the convolutional neural network. In the convolutional layer of the convolutional neural network, one neuron may be connected to only a part of neurons in a neighboring layer. A convolutional layer generally includes several feature planes, and each feature plane may include some neurons arranged in a rectangle. Neurons of a same feature plane share a weight, and the shared weight herein is a convolution kernel. Sharing the weight may be understood as that a manner of extracting image information is unrelated to a position. The convolution kernel may be initialized in a form of a matrix of a random size. In a training process of the convolutional neural network, an appropriate weight may be obtained for the convolution kernel through learning. In addition, sharing the weight is advantageous because connections between layers of the convolutional neural network are reduced, and a risk of overfitting is reduced.

(4) Residual Network

A residual network is a deep convolutional network first proposed in 2015. Compared with a conventional convolutional neural network, a residual network is easier to optimize and can enhance accuracy by increasing a depth considerably. Essentially, a residual network resolves side effects (deterioration) brought by a depth increase. In this way, network performance can be improved by simply increasing a network depth. A residual network generally includes a plurality of sub-modules with a same structure. A residual network (residual network, ResNet) plus a number indicates a quantity of times of sub-module repetition. For example, ResNet50 represents that there are 50 sub-modules in a residual network.

(6) Classifier

Many neural architectures have a classifier at the end to classify an object in an image. A classifier generally includes a fully connected layer (fully connected layer) and a softmax function (which may be referred to as a normalized exponential function), and can output probabilities of different classes based on input.

(7) Loss Function

In a process of training a deep neural network, because it is expected that output of the deep neural network is as close as possible to a value that is actually expected to be predicted, a current predicted value of the network may be compared with a target value that is actually expected, and then a weight vector at each layer of the neural network is updated based on a difference between the current predicted value and the target value (there is usually an initialization process before a first update, that is, a parameter is preconfigured for each layer of the deep neural network). For example, if the predicted value of the network is large, the weight vector is adjusted to lower the predicted value until the deep neural network can predict the target value that is actually expected or a value close to the target value that is actually expected. Therefore, “how to obtain, through comparison, the difference between the predicted value and the target value” needs to be predefined. This is the loss function (loss function) or an objective function (objective function). The loss function and the objective function are important equations used to measure the difference between the predicted value and the target value. The loss function is used as an example. A higher output value (loss) of the loss function indicates a larger difference. Therefore, training of the deep neural network is a process of minimizing the loss as much as possible.

(8) Back Propagation Algorithm

The neural network may correct a value of a parameter in an initial neural network model in a training process by using an error back propagation (back propagation, BP) algorithm, so that an error loss of reconstructing the neural network model becomes small. Specifically, an input signal is forward transferred until an error loss occurs in output, and the parameters in the initial neural network model are updated based on back propagation error loss information, so that the error loss is reduced. The back propagation algorithm is a back propagation motion mainly dependent on the error loss, and aims to obtain parameters of an optimal neural network model, for example, a weight matrix.

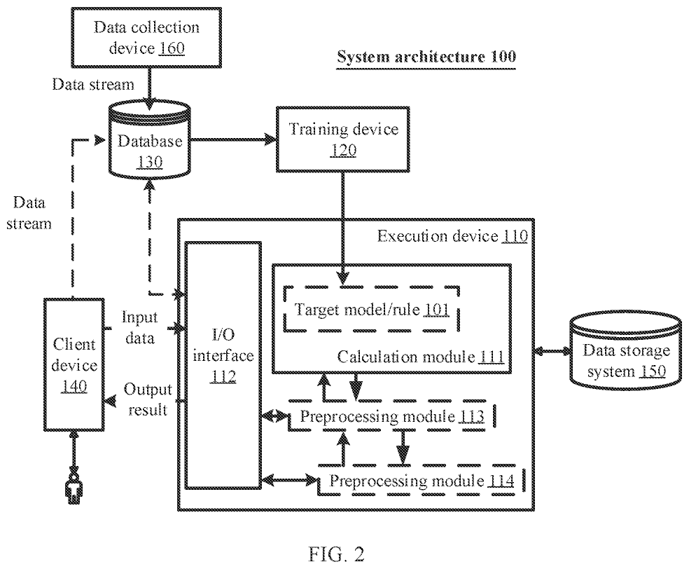

FIG. 2 shows a system architecture 100 according to an embodiment of this application. In FIG. 2, a data collection device 160 is configured to collect training data. In an image processing method in this embodiment of this application, the training data may include a training image and a label of the training image (where if the image is classified, the label may be a result of classifying the training image), where the training image may be labeled in advance manually.

After collecting the training data, the data collection device 160 stores the training data in a database 130, and a training device 120 obtains a target model/rule 101 through training based on the training data maintained in the database 130.

The following describes a process of obtaining the target model/rule 101 by the training device 120 based on the training data. Specifically, the training device 120 processes an input training image, to obtain a result of processing the training image, compares the result of processing the training image with a label of the training image, and continues to train the target model/rule 101 based on comparison of the result of processing the training image with the label of the training image, until a difference between the result of processing the training image and the label of the training image satisfies a requirement, thereby completing training of the target model/rule 101.

The target model/rule 101 can be used to implement the image processing method in this embodiment of this application. The target model/rule 101 in this embodiment of this application may specifically be a neural network. It should be noted that, in actual application, the training data maintained in the database 130 is not necessarily collected by the data collection device 160, but may be received from another device. It should be further noted that the training device 120 may not necessarily train the target model/rule 101 completely based on the training data maintained in the database 130, or may obtain training data from a cloud or another place to perform model training. The foregoing description should not be construed as a limitation on the embodiments of this application.

The target model/rule 101 obtained through training by the training device 120 may be applied to different systems or devices, for example, an execution device 110 shown in FIG. 2. The execution device 110 may be a terminal, for example, a mobile phone terminal, a tablet, a laptop computer, an augmented reality (augmented reality, AR) AR/virtual reality (virtual reality, VR) terminal, or a vehicle-mounted terminal, or may be a server, a cloud, or the like. In FIG. 2, the execution device 110 configures an input/output (input/output, I/O) interface 112, configured to exchange data with an external device. A user may input data to the I/O interface 112 by using a client device 140, where the input data in this embodiment of this application may include a to-be-processed image input by the client device.

A preprocessing module 113 and a preprocessing module 114 are configured to perform preprocessing based on the input data (for example, the to-be-processed image) received by the I/O interface 112. In this embodiment of this application, the preprocessing module 113 and the preprocessing module 114 may not exist (or only one of the preprocessing module 113 and the preprocessing module 114 exists). A computing module 111 is directly configured to process the input data.

In a process in which the execution device 110 performs preprocessing on the input data or the computing module 111 of the execution device 110 performs related processing such as calculation, the execution device 110 may invoke data, code, and the like in a data storage system 150 for corresponding processing, and may also store data, instructions, and the like obtained through corresponding processing into the data storage system 150.

It should be noted that the training device 120 may generate corresponding target models/rules 101 for different targets or different tasks based on different training data. The corresponding target models/rules 101 may be used to implement the foregoing targets or complete the foregoing tasks, to provide a desired result for the user,

In FIG. 2, a user may manually enter input data (where the input data may be a to-be-processed image), and the manual operation may be performed through an interface provided by the I/O interface 112. In another case, the client device 140 may automatically send input data to the I/O interface 112. If it is required that the client device 140 needs to obtain authorization from the user to automatically send the input data, the user may set corresponding permission on the client device 140. The user may view, on the client device 140, a result output by the execution device 110. Specifically, the result may be presented in a form of displaying, a sound, an action, or the like. The client device 140 may also serve as a data collection end to collect, as new sample data, input data that is input into the I/O interface 112 and an output result that is output from the I/O interface 112 that are shown in the figure, and store the new sample data into the database 130. Certainly, the client device 140 may alternatively not perform collection, but the I/O interface 112 directly stores, as new sample data into the database 130, input data that is input into the I/O interface 112 and an output result that is output from the I/O interface 112 that are shown in the figure.

It should be noted that FIG. 2 is merely a schematic diagram of the system architecture according to an embodiment of this application. A location relationship between a device, a component, a module, and the like shown in the figure constitutes no limitation. For example, in FIG. 2, the data storage system 150 is an external memory to the execution device 110. In another case, the data storage system 150 may alternatively be disposed in the execution device 110.

As shown in FIG. 2, the target model/rule 101 is obtained through training by the training device 120. The target model/rule 101 may be a neural network in this embodiment of this application. Specifically, the neural network provided in this embodiment of this application may be a CNN, a deep convolutional neural network (deep convolutional neural network, DCNN), a recurrent neural network (recurrent neural network, RNN), or the like.

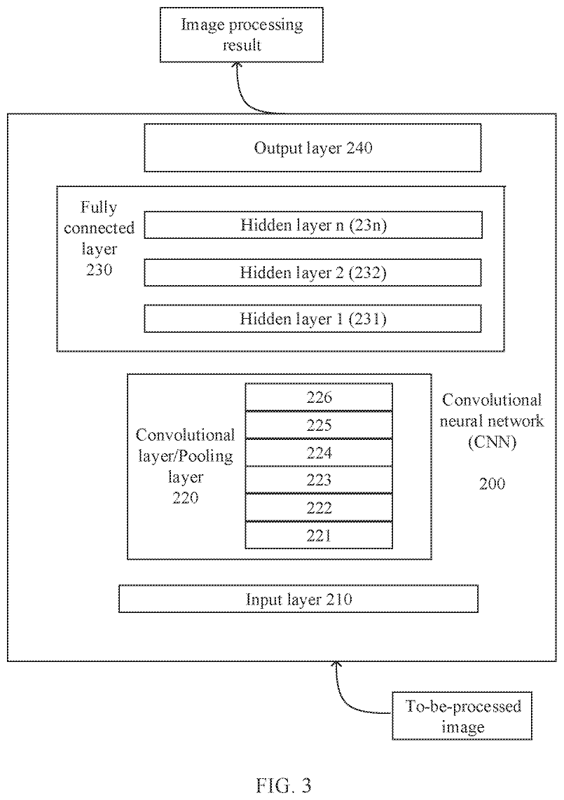

Because the CNN is a very common neural network, a structure of the CNN is described below in detail with reference to FIG. 3. As described in the foregoing description of basic concepts, the convolutional neural network is a deep neural network with a convolutional structure, and is a deep learning (deep learning) architecture. The deep learning architecture is to perform multi-level learning at different abstract levels by using a machine learning algorithm. As a deep learning architecture, the CNN is a feed-forward (feed-forward) artificial neural network, and each neuron in the feed-forward artificial neural network can respond to an image input into the feed-forward artificial neural network.

An architecture of a neural network specifically used in the image processing method in this embodiment of this application may be shown in FIG. 3. In FIG. 3, a convolutional neural network (CNN) 200 may include an input layer 210, a convolutional layer/pooling layer 220 (the pooling layer is optional), and a neural network layer 230. be input layer 210 may obtain a to-be-processed image, and send the obtained to-be-processed image to the convolutional layer/pooling layer 220 and the subsequent neural network layer 230 for processing, to obtain a processing result of the image. The following describes in detail an architecture of the layer in the CNN 200 in FIG. 3.

Convolutional layer/Pooling layer 220:

Convolutional layer:

As shown in FIG. 3, the convolutional layer/pooling layer 220 may include, for example, layers 221 to 226. For example, in an implementation, the layer 221 is a convolutional layer, the layer 222 is a pooling layer, the layer 223 is a convolutional layer, the layer 224 is a pooling layer, the layer 225 is a convolutional layer, and the layer 226 is a pooling layer; and in another implementation, the layers 221 and 222 are convolutional layers, the 223 layer is a pooling layer, the layers 224 and 225 are convolutional layers, and the layer 226 is a pooling layer. In other words, output of a convolutional layer may be used as input for a subsequent pooling layer, or may be used as input for another convolutional layer, to continue to perform a convolution operation.

The following describes internal working principles of the convolutional layer by using the convolutional layer 221 as an example.

The convolutional layer 221 may include a plurality of convolution operators. The convolution operator is also referred to as a kernel. In image processing, the convolution operator functions as a filter that extracts specific information from an input image matrix. The convolution operator may essentially be a weight matrix, and the weight matrix is usually predefined. In a process of performing a convolution operation on an image, the weight matrix usually processes pixels at a granularity level of one pixel (or two pixels, depending on a value of a stride (stride)) in a horizontal direction on an input image, to extract a specific feature from the image. A size of the weight matrix should be related to a size of the image. It should be noted that a depth dimension (depth dimension) of the weight matrix is the same as a depth dimension of the input image. During a convolution operation, the weight matrix extends to an entire depth of the input image. Therefore, a convolutional output of a single depth dimension is generated through convolution with a single weight matrix. However, in most cases, a single weight matrix is not used, but a plurality of weight matrices with a same size (rows×columns), namely, a plurality of same-type matrices, are applied. Outputs of the weight matrices are superimposed to form a depth dimension of a convolutional image. The dimension herein may be understood as being determined based on the foregoing “plurality”. Different weight matrices may be used to extract different features from the image. For example, one weight matrix is used to extract edge information of the image, another weight matrix is used to extract a specific color of the image, and a further weight matrix is used to blur unneeded noise in the image. The plurality of weight matrices have the same size (rows×columns), and convolutional feature maps extracted from the plurality of weight matrices with the same size have a same size. Then, the plurality of extracted convolutional feature maps with the same size are combined to form output of the convolution operation.

Weight values in these weight matrices need to be obtained through a lot of training during actual application. Each weight matrix formed by using the weight values obtained through training may be used to extract information from an input image, to enable the convolutional neural network 200 to perform correct prediction.

When the convolutional neural network 200 has a plurality of convolutional layers, an initial convolutional layer (for example, the layer 221) usually extracts more general features, where the general features may also be referred to as low-level features. As a depth of the convolutional neural network 200 increases, a deeper convolutional layer (for example, the layer 226) extracts more complex features, such as high-level semantic features. Higher-level semantic features are more applicable to a problem to be resolved.

Pooling layer:

Because a quantity of training parameters usually needs to be reduced, a pooling layer usually needs to be periodically introduced after a convolutional layer. To be specific, for the layers 221 to 226 in the layer 220 shown in FIG. 3, one convolutional layer may be followed by one pooling layer, or a plurality of convolutional layers may be followed by one or more pooling layers. During image processing, the pooling layer is only used to reduce a space size of the image. The pooling layer may include an average pooling operator and/or a maximum pooling operator, to perform sampling on the input image to obtain an image with a relatively small size. The average pooling operator may be used to calculate pixel values in the image in a specific range, to generate an average value. The average value is used as an average pooling result. The maximum pooling operator may be used to select a pixel with a maximum value in a specific range as a maximum pooling result. In addition, similar to that the size of the weight matrix at the convolutional layer needs to be related to the size of the image, an operator at the pooling layer also needs to be related to the size of the image. A size of a processed image output from the pooling layer may be less than a size of an image input to the pooling layer. Each pixel in the image output from the pooling layer represents an average value or a maximum value of a corresponding sub-region of the image input to the pooling layer.

Neural network layer 230:

After processing is performed by the convolutional layer/pooling layer 220, the convolutional neural network 200 still cannot output required output information. As described above, at the convolutional layer/pooling layer 220, only a feature is extracted, and parameters resulting from an input image are reduced. However, to generate final output information (required class information or other related information), the convolutional neural network 200 needs to use the neural network layer 230 to generate output of one required class or outputs of a group of required classes. Therefore, the neural network layer 230 ay include a plurality of hidden layers (231, 232, . . . , and 23n shown in FIG. 3) and an output layer 240. Parameters included in the plurality of hidden layers may be obtained through pre-training based on related training data of a specific task type. For example, the task type may include image recognition, image classification, super-resolution image reconstruction, and the like.

At the neural network layer 230, the plurality of hidden layers are followed by the output layer 240, namely, the last layer of the entire convolutional neural network 200. The output layer 240 has a loss function similar to a categorical cross entropy, and the loss function is specifically configured to calculate a prediction error. Once forward propagation (for example, propagation in a direction from 210 to 240 in FIG. 3) of the entire convolutional neural network 200 is completed, back propagation (for example, propagation in a direction from 240 to 210 in FIG. 3) is started to update a weight value and a deviation of each layer mentioned above, to reduce a loss of the convolutional neural network 200 and an error between a result output by the convolutional neural network 200 by using the output layer and an ideal result.

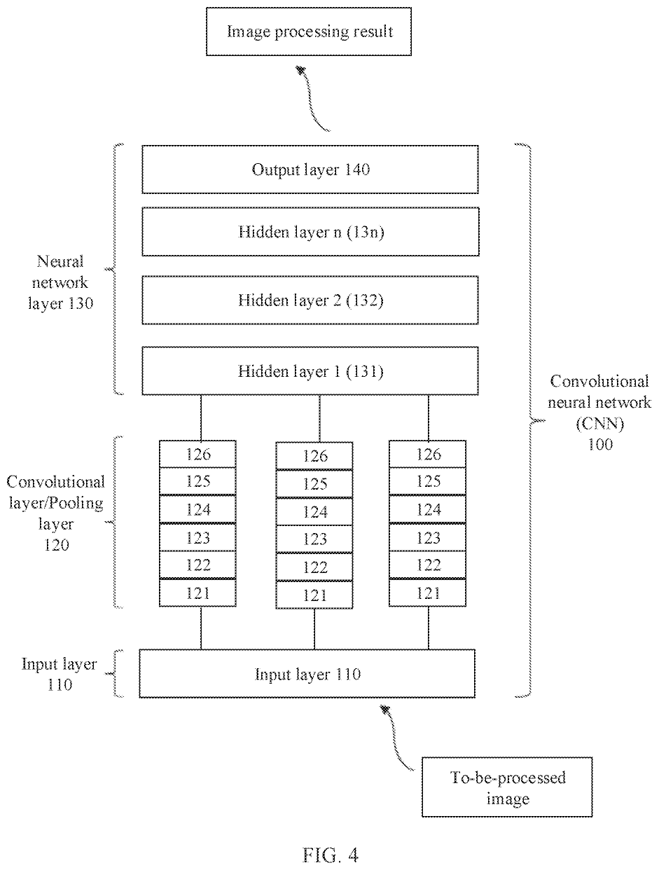

An architecture of a neural network specifically used in the image processing method in this embodiment of this application may be shown in FIG. 4. In FIG. 4, a convolutional neural network (CNN) 200 may include an input layer HO, a convolutional layer/pooling layer 120 (the pooling layer is optional), and a neural network layer 130. Compared with FIG. 3, in FIG. 4, at the convolutional layer/pooling layer 120, a plurality of convolutional layers/pooling layers are in parallel, and extracted features are input to the neural network layer 130 for processing.

It should be noted that the convolutional neural network shown in FIG. 3 and the convolutional neural network shown in FIG. 4 are merely two example convolutional neural networks used in the image processing method in this embodiment of this application. In a specific application, the convolutional neural network used in the image processing method in this embodiment of this application may alternatively exist in a form of another network model.

In addition, an architecture of a convolutional neural network obtained by using the neural architecture search method in this embodiment of this application may be shown in the architecture of the convolutional neural network in FIG. 3 and the architecture of the convolutional neural network FIG. 4.

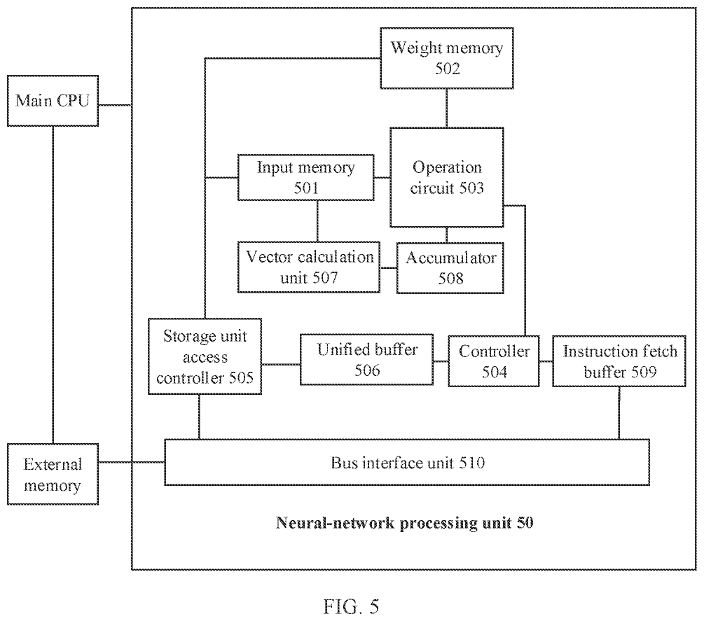

FIG. 5 is a schematic diagram of a hardware architecture of a chip according to an embodiment of this application. The chip includes a neural-network processing unit 50. The chip may be disposed in the execution device 110 shown in FIG. 2, so as to complete calculation work of the computing module 111. The chip may be alternatively disposed in the training device 120 shown in FIG. 2, so as to complete training work of the training device 120 and output the target model/rule 101. Algorithms at all layers of the convolutional neural network shown in FIG. 3 or the convolutional neural network shown in FIG. 4 may be implemented in the chip shown in FIG. 5.

The neural-network processing unit NPU 50 serves as a coprocessor, and may be disposed on a host central processing unit (central processing unit, CPU) (host CPU). The host CPU assigns a task. A core part of the NPU is an operation circuit 50, and a controller 504 controls the operation circuit 503 to extract data in a memory (a weight memory or an input memory) and perform an operation.

In some implementations, the operation circuit 503 includes a plurality of processing units (process engine, PE) inside. In some implementations, the operation circuit 503 is a two-dimensional systolic array. The operation circuit 503 may alternatively be a one-dimensional systolic array or another electronic circuit capable of performing mathematical operations such as multiplication and addition. In some implementations, the operation circuit 503 is a general-purpose matrix processor.

For example, it is assumed that there are an input matrix A, a weight matrix B, and an output matrix C. The operation circuit fetches, from a weight memory 502, data corresponding to the matrix B, and caches the data on each PE in the operation circuit. The operation circuit fetches data of the matrix A from an input memory 501, to perform a matrix operation on the matrix B, and stores an obtained partial result or an obtained final result of the matrix in an accumulator (accumulator) 508.

A vector calculation unit 507 may perform further processing such as vector multiplication, vector addition, an exponent operation, a logarithm operation, or value comparison on output of the operation circuit. For example, the vector calculation unit 507 may be configured to perform network calculation, such as pooling (pooling), batch normalization (batch normalization), or local response normalization (local response normalization) at a non-convolutional/non-FC layer in a neural network.

In some implementations, the vector calculation unit 507 can store a processed output vector in a unified memory 506. For example, the vector calculation unit 507 can apply a non-linear function to output of the operation circuit 503, for example, a vector of an accumulated value, used to generate an activated value, in some implementations, the vector calculation unit 507 generates a normalized value, a combined value, or both a normalized value and a combined value. In some implementations, the processed output vector can be used as an activated input to the operation circuit 503, for example, the processed output vector can be used at a subsequent layer of the neural network.

The unified memory 506 is configured to store input data and output data.

For weight data, a direct memory access controller (direct memory access controller, DMAC) 505 directly transfers input data in an external memory to the input memory 501 and/or the unified memory 506, stores weight data in the external memory in the weight memory 502, and stores data in the unified memory 506 in the external memory.

A bus interface unit (bus interface unit, BIU) 510 is configured to implement interaction between the host CPU, the DMAC, and an instruction fetch buffer 509 by using a bus.

The instruction fetch buffer (instruction fetch buffer) 509 connected to the controller 504 is configured to store instructions used by the controller 504.

The controller 504 is configured to invoke the instructions cached in the instruction fetch buffer 509, to control a working process of an operation accelerator.

Entry: Data herein may be described as description data according to an actual invention, for example, a detected vehicle speed, a distance to an obstacle, and the like.

Usually, the unified memory 506, the input memory 501, the weight memory 502, and the instruction fetch buffer 509 each are an on-chip (On-Chip) memory. The external memory is a memory outside the NPU. The external memory may be a double data rate synchronous dynamic random access memory (double data rate synchronous dynamic random access memory, DDR SDRAM for short), a high bandwidth memory (high bandwidth memory, HBM), or another readable and writable memory.

An operation of each layer in the convolutional neural network shown in FIG. 3 or the convolutional neural network FIG. 4 may be performed by the operation circuit 303 or the vector calculation unit 307.

The execution device 110 in FIG. 2 can perform steps of the image processing method in this embodiment of this application. The CNN model shown in FIG. 3 and the CNN model shown in FIG. 4 and the chip shown in FIG. 5 may also be configured to perform the steps of the image processing method in this embodiment of this application. The following describes the image processing method according to an embodiment of this application in detail with reference to the accompanying drawings.

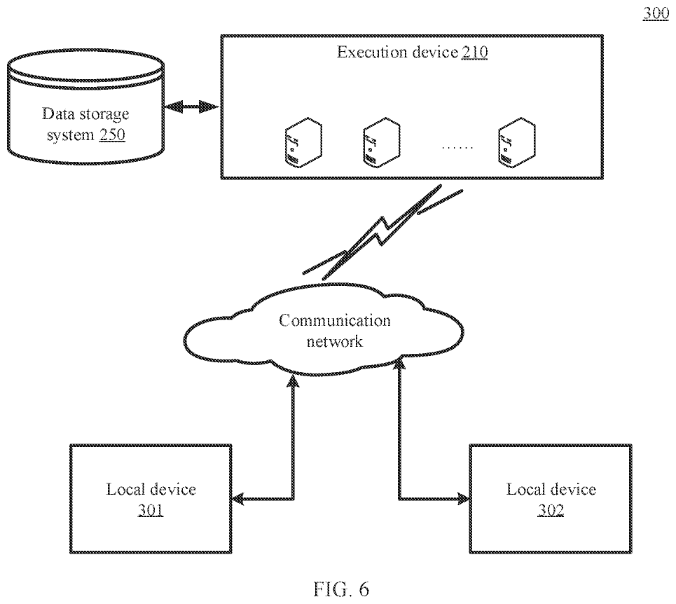

FIG. 6 shows a system architecture 300 according to an embodiment of this application. The system architecture includes a local device 301, a local device 302, an execution device 210, and a data storage system 250. The local device 301 and the local device 302. are connected to the execution device 210 by using a communication network.

The execution device 210 ay be implemented by one or more servers. Optionally, the execution device 210 may cooperate with another computing device, for example, a device such as a data memory, a router, or a load balancer: The execution device 210 may be disposed on one physical site, or distributed on a plurality of physical sites. The execution device 210 may implement the neural architecture search method in this embodiment of this application by using data in the data storage system 250 or by invoking program code in the data storage system 250.

Specifically, the execution device 210 may be configured to: determine a search space and a plurality of construction units; superimpose the plurality of construction units to obtain a search network, where the search network is a neural network used to search for a neural architecture; optimize, in the search space, network architectures of the construction units in the search network, to obtain optimized construction units, where in an optimizing process, the search space gradually decreases, and a quantity of construction units gradually increases, so that a video random access memory resource consumed in an optimizing process falls within a preset range; and establish a target neural network based on the optimized construction units.

The execution device 210 may establish the target neural network through the foregoing process, and the target neural network may be used for image classification, image processing, or the like.

A user may operate user equipment (for example, the local device 301 and the local device 302) to interact with the execution device 210. Each local device may be any computing device, such as a personal computer, a computer workstation, a smartphone, a tablet computer, an intelligent camera, a smart automobile, another type of cellular phone, a media consumption device, a wearable device, a set-top box, or a game console.

A local device of each user may interact with the execution device 210 through a communication network of any communication mechanism/communication standard. The communication network may be a wide area network, a local area network, a point-to-point connection, or any combination thereof.

In an implementation, the local device 301 and the local device 302 obtain a related parameter of the target neural network from the execution device 210, deploy the target neural network on the local device 301 and the local device 302, and perform image classification, image processing, or the like by using the target neural network.

In another implementation, the target neural network may be directly deployed on the execution device 210 The execution device 210 obtains a to-be-processed image from the local device 301 and the local device 302, and performs classification or another type of image processing on the to-be-processed image based on the target neural network.

The execution device 210 may also be referred to as a cloud device. In this case, the execution device 210 is usually deployed on a cloud.

The following provides corresponding analysis of problems in neural architecture (which may also be referred to as neural network structure) search.

During neural architecture search, a feasible solution is differentiable architecture search (differentiable architecture search, DARTS). However, in neural network search through DARTS, there is a problem of multicollinearity (multicollinearity).

Specifically, in neural architecture search through DARTS, when there are operators with high correlation, a weight of each operator determined in a searching process may not reflect actual importance of each operator, so that an actually important operator may be removed in a process of selecting an operator, and consequently, a neural network finally obtained through searching is not with good performance.

For example, there are three operators, that is, a convolution, max pooling, and average pooling (where a degree of linear correlation between max pooling and average pooling is as high as 0.9) in the searching process. The convolution is weighted 0.4, and max pooling and average pooling each are weighted 0.3. In this case, the convolution is selected as a final operation based on a principle of taking the largest weight. However, because of a high degree of linear correlation between max pooling and average pooling, max pooling and average pooling may be approximately considered as one pooling operation. In this case, the pooling operation is weighted 0.6, and the convolution is weighted 0.4, so that the pooling operation is selected as a final operation, but the convolution is selected as a final operation in a conventional solution. Operator selection is not accurate, and consequently, a neural network finally obtained through searching is not with good performance.

To overcome the problem of multi collinearity, in a process of neural network search, there may be two stages in an optimization process. A type of alternative operations corresponding to each edge of a structuring element is first determined in the first stage in the optimization process (and a type of an operator with a largest weight on each edge is determined), and a specific operator on each edge of the structuring element is then determined at the second stage, so that the problem of multicollinearity can be avoided in the process of neural network search, and a target neural network with better performance can be built.

The following describes in detail a neural architecture search method according to an embodiment of this application with reference to the accompanying drawings.

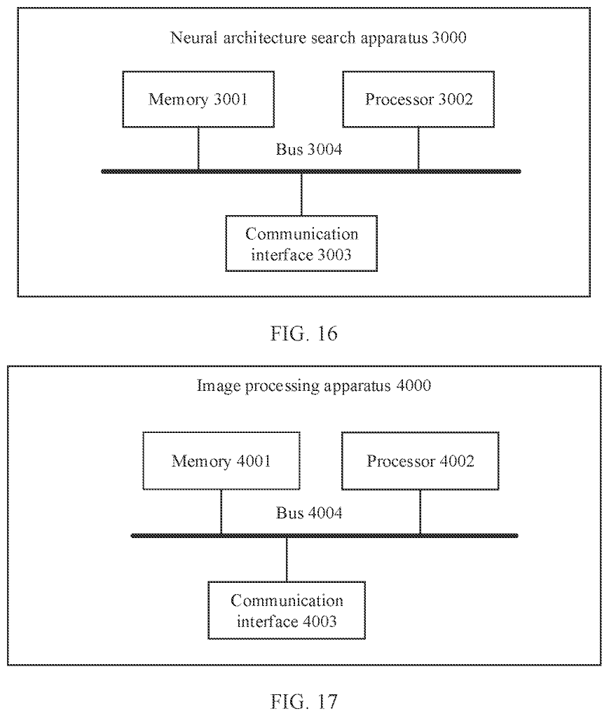

FIG. 7 is a schematic flowchart of a neural architecture search method according to an embodiment of this application; and the method shown in FIG. 7 may be performed by a neural architecture search apparatus in the embodiments of this application (where for example, the method shown in FIG. 7 may be performed by a neural architecture search apparatus shown in FIG. 16). The method shown in FIG. 7 includes step 1001 to step 1006. The following describes these steps in detail.

1001: Determine a search space and a plurality of construction units.

The search space in step 1001 includes a plurality of groups of alternative operators, each group of alternative operators includes at least one operator, and types of operators in each group of alternative operators are the same (that is, the at least one operator in each group of operators is of a same type).

Optionally, the search space includes four groups of alternative operators, and the four groups of alternative operators specifically include the following operators:

a first group of alternative operators, including 3×3 max pooling (3×3 max pooling or max_pool_3×3) and 3×3 average pooling (3×3 average pooling or avg_pool_3×3);

a second group of alternative operators, including a skip connection (identity or skip-connect);

a third group of alternative operators, including 3×3 separable convolutions (3×3 separable convolutions or sep_conv_3×3), and 5×5 separable convolutions (5×5 separable convolutions or sep_conv_5×5); and

a fourth group of alternative operators, including 3×3 dilated separable convolutions (3×3 dilated separable convolutions), and 5×5 dilated separable convolutions (5×5 dilated separable convolutions).

Optionally, the search space is determined based on an application requirement of a to-be-established target neural network.

Specifically, the search space may be determined based on a type of data processed by the target neural network.

When the target neural network is a neural network used to process image data, types and a quantity of operations included in the search space need to adapt to image data processing.

For example, when the target neural network is a neural network used to process image data, the search space may include a convolution operation, a pooling operation, a skip connection operation, and the like.

When the target neural network is a neural network used to process voice data, types and a quantity of operations included in the search space need to adapt to voice data processing.

For example, when the target neural network is a neural network used to process voice data, the search space may include an activation function (for example, ReLU or Tanh) and the like,

Optionally, the search space is determined based on an application requirement of the target neural network and graphics processing unit memory resources of the neural architecture search device performing the method shown in FIG. 7.

The condition of the video random access memory resource of the device performing neural architecture searching may be a size of the video random access memory resource of the device performing neural architecture searching.

The types and the quantity of operations included in the search space may be determined based on the application requirement of the target neural network and the condition of the video random access memory resource of the device performing neural architecture searching.

Specifically, the types and the quantity of operations included in the search space may be first determined based on the application requirement of the target neural network, and then the types and the quantity of operations included in the search space are adjusted based on the condition of the video random access memory resource of the device performing neural architecture searching, to determine types and a quantity of operations finally included in the search space.

For example, after the types and the quantity of operations included in the search space are determined based on the application requirement of the target neural network, if there are relatively few video random access memory resources of the device performing neural architecture searching, some operations that are less important in the search space may be deleted. If there are relatively sufficient video random access memory resources of the device performing neural architecture searching, the types and the quantity of operations included in the search space may remain unchanged, or the types and the quantity of operations included in the search space are increased.

In addition, each of the plurality of structuring elements (which may also be referred to as a cell) in step 1001 is a network structure that is between a plurality of nodes and that is obtained by connecting basic operators of a neural network, and the nodes of each of the plurality of structuring elements are connected to form an edge.

One structuring element may be considered as a directed acyclic graph (directed acyclic graph, DAG), and each structuring element is formed by connecting N (where N is an integer greater than 1) ordered nodes with directed edges. Each node represents one feature map, and each directed edge indicates that one type of operators are used to process an input feature map. For example, a directed edge (i, j) indicates connection from a node i to a node j, and an operator o∈O on the directed edge (i, j) is used to convert a feature map x_i input by the node i into a feature map x_j. O represents all alternative operations in the search space.

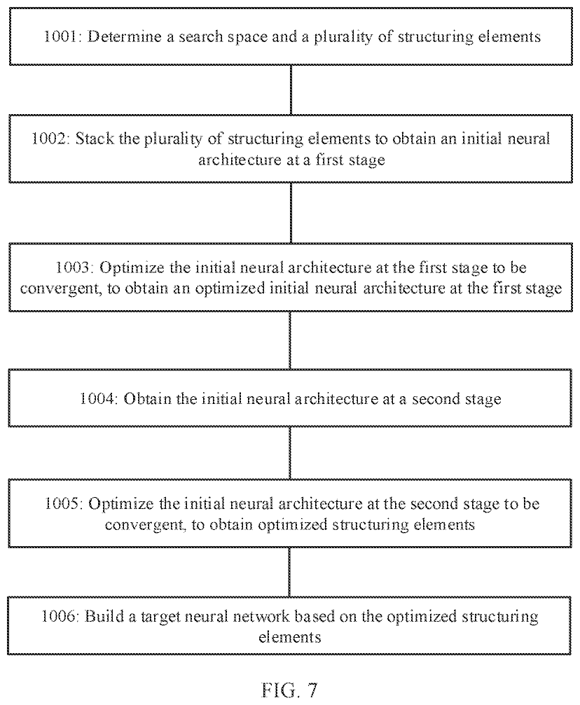

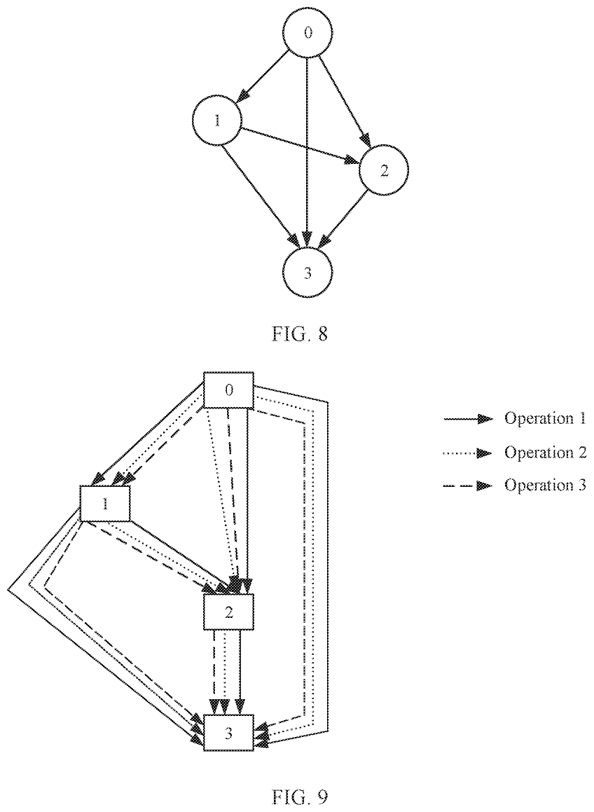

As shown in FIG. 8, the structuring element is formed by connecting four nodes (which are nodes 0, 1, 2, and 3 respectively) with directed edges, where the nodes 0, 2, and 3 each represent a feature map. In this structuring element, there are six directed edges in total, and the six directed edges respectively are: a directed edge (0, 1), a directed edge (0, 2), a directed edge (0, 3), a directed edge (1, 2), a directed edge (1, 3), and a directed edge (2, 3).

Optionally, a quantity of the plurality of structuring elements determined in step 1001 is determined based on graphics processing unit memory resources of the device performing neural architecture search.

Specifically, when there are only a few graphics processing unit memory resources of the neural architecture search apparatus performing the method shown in FIG. 7, there can be a smaller quantity of structuring elements, but when there are abundant graphics processing unit memory resources of the neural architecture search apparatus performing the method shown in FIG. 7, there can be a larger quantity of structuring elements.

Optionally, the quantity of construction units is determined based on the application requirement of the to-be-established target neural network and the condition of the video random access memory resource of the device performing neural architecture searching.

Specifically, an initial quantity of construction units may be first determined based on the application requirement of the target neural network, and then the initial quantity of construction units is further adjusted based on the video random access memory resource of the device performing neural architecture searching, to determine a final quantity of construction units.

For example, after the initial quantity of construction units is determined based on the application requirement of the target neural network, if there are relatively few video random access memory resources of the device performing neural architecture searching, the quantity of construction units may further be reduced. If there are relatively sufficient video random access memory resources of the device performing neural architecture searching, the initial quantity of construction units remains unchanged. In this case, the initial quantity of construction units is the final quantity of construction units.

1002: Stack the plurality of structuring elements to obtain an initial neural architecture at a first stage.

For example, in step 1002, the plurality of structuring elements shown in FIG. 8 are stacked to obtain the initial neural architecture at the first stage.

1003: Optimize the initial neural architecture at the first stage to be convergent, to obtain an optimized initial neural architecture at the first stage.

1004: Obtain the initial neural architecture at a second stage.

Structures of the initial neural architecture at the first stage and the initial neural architecture at the second stage are the same.

Specifically, types and a quantity of the structuring elements in the initial neural architecture at the first stage are the same as types and a quantity of structuring elements in the initial neural architecture at the second stage. In addition, a structure of an structuring element in the initial neural architecture at the first stage is exactly the same as a structure of an structuring element in the initial neural architecture at the second stage, where i is a positive integer.

A difference between the initial neural architecture at the first stage and the initial neural architecture at the second stage is that alternative operators corresponding to corresponding edges in corresponding structuring elements are different.

Specifically, each edge of each structuring element in the initial neural architecture at the first stage corresponds to a plurality of alternative operators, and each of the plurality of alternative operators corresponds to one group in the plurality of groups of alternative operators.

A mixed operator corresponding to a j^{th} edge of an i^{th} structuring element in the initial neural architecture at the second stage includes all operators in a k^{th} group of alternative operators in the optimized initial neural architecture at the first stage, the k^{th} group of alternative operators is a group of alternative operators including an operator with a largest weight in a plurality of alternative operators corresponding to the j^{th} edge of the i^{th} structuring element in the optimized initial neural architecture at the first stage, and i, j, and k are all positive integers.

When the neural architecture is optimized in step 1003 and step 1004, specifically, an optimization method such as stochastic gradient descent (stochastic gradient descent, SGD) may be used for optimization.

1005: Optimize the initial neural architecture at the second stage to be convergent, to obtain optimized structuring elements.

The optimized structuring elements may be referred to as optimal structuring elements, and the optimized structuring elements are used to build or stack a required target neural network.

The following describes structuring elements in the initial neural architecture at the first stage and structuring elements in the initial neural architecture at the second stage with reference to the accompanying drawings.

For example, a structuring element in the initial neural architecture at the first stage may be shown in FIG. 9. As shown in FIG. 9, in the structuring element, a plurality of alternative operators corresponding to each edge include an operation 1, an operation 2, and an operation 3. Herein, the operation 1, the operation 2, and the operation 3 may be operations selected from the first group of alternative operators, the third group of alternative operators, and the fourth group of alternative operators respectively. Specifically, the operation 1 may be 3×3 max pooling in the first group of alternative operators, the operation 2 may be 3×3 separable convolutions in the third group of alternative operators, and the operation 3 may be 3×3 dilated separable convolutions in the fourth group of alternative operators.

It should be understood that, to facilitate description, only three alternative operations are shown on each edge of the structuring element in FIG. 9. In this case, a corresponding search space may include only three groups of alternative operations, and the three alternative operations corresponding to each edge are selected from the three groups of alternative operations separately.

In step 1003, after the initial neural architecture at the first stage is optimized, the optimized initial neural architecture at the first stage is obtained.

For example, a structuring element in the optimized initial neural architecture at the first stage may be shown in FIG. 10. After the structuring element shown in FIG. 9 is optimized, a weight of each alternative operator on each edge may be obtained. As shown in FIG. 10, a thickened operation on each edge represents an operator with a largest weight on the edge.

Specifically, in FIG. 10, an operator with a largest weight on each edge of the structuring element is shown in Table 1.

TABLE 1

| Directed edge | Operator with a largest weight |
|---|---|
| 0-1 | Operation 3 |
| 0-2 | Operation 1 |
| 0-3 | Operation 1 |
| 1-2 | Operation 1 |
| 1-3 | Operation 2 |
| 2-3 | Operation 3 |

An operator with a largest weight on a j^{th} edge of an i^{th} structuring element in the optimized initial neural architecture at the first stage is replaced with a mixed operator including all operators in a group of alternative operators in which there is the operator with the largest weight, and the initial neural architecture at the second stage can be obtained.

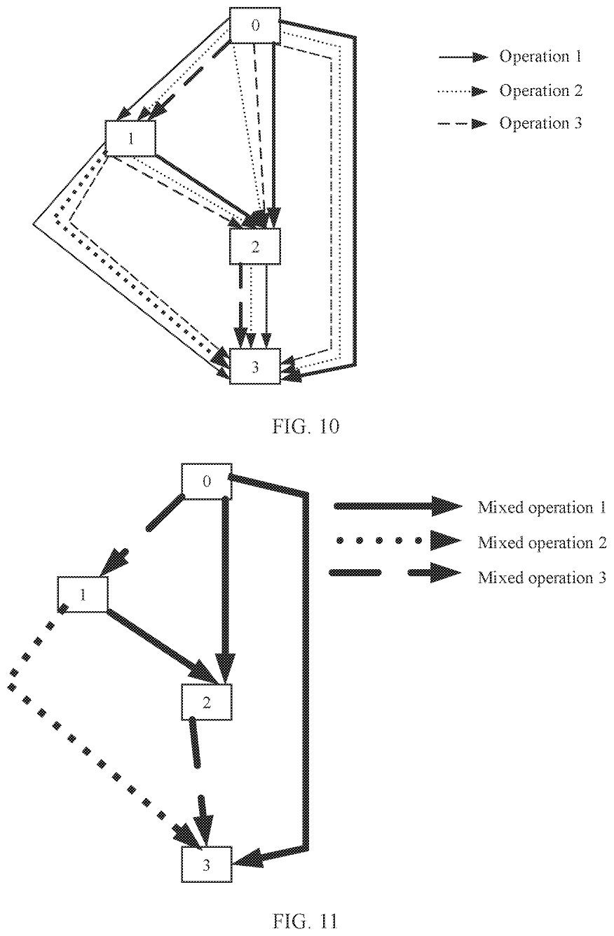

For example, an operator with a largest weight on each edge of a structuring element shown in FIG. 10 is replaced with a mixed operator including all operators in a group of alternative operators in which there is the operator with the largest weight, and a structuring element shown in FIG. 11 can be obtained.

Specifically, specific composition of a mixed operation in the structuring element in FIG. 11 may be shown in Table 2.

TABLE 2

| Mixed operation | Included operator |
|---|---|
| Mixed operation 1 | All operators in a group of alternative |
| | operators including the operation 1 |
| Mixed operation 2 | All operators in a group of alternative |
| | operators including the operation 2 |
| Mixed operation 3 | All operators in a group of alternative |
| | operators including the operation 3 |

When the operation 1 is 3×3 max pooling in the first group of alternative operators, the operation 2 is 3×3 separable convolutions in the third group of alternative operators, the operation 3 is 3×3 dilated separable convolutions in the fourth group of alternative operators, and specific composition of the mixed operation 1 to the mixed operation 3 may be shown in Table 3.

TABLE 3

| Mixed operation | Included operator |
|---|---|
| Mixed operation 1 | 3 × 3 max pooling and 3 × 3 average pooling |
| Mixed operation 2 | 3 × 3 separable convolutions and 5 × 5 separable |
| | convolutions |
| Mixed operation 3 | 3 × 3 dilated separable convolutions and 5 × 5 |
| | dilated separable convolutions |

In step 1005, in a process of optimizing the initial neural architecture at the second stage, a specific operator on each edge of each structuring element in the initial neural architecture at the second stage may be determined.

A structuring element in the initial neural architecture at the second stage may be shown in FIG. 11. In step 1005, the structuring element shown in FIG. 11 may continue to be optimized, to determine an operator with a largest weight on each edge of the structuring element, and determine the operator with the largest weight on the edge as a final operator on the edge.

For example, an operation on an edge from a node 1 to a node 2 in FIG. 11 is the mixed operation 1, and the mixed operation 1 is a mixed operation including 3×3 max pooling and 3×3 average pooling. Then, in the optimization process in step 1005, weights of 3×3 max pooling and 3×3 average pooling needs to be separately determined, and an operation with a larger weight is determined as a final operation on the edge from the node 1 to the node 2.

1006: Finally, build a target neural network based on the optimized structuring elements.

In this application, in a process of neural architecture search, which type of alternative operators should be used for each edge of each structuring element is determined at the first stage in the optimization process, and which specific alternative operator should be used for each edge of each structuring element is determined at the second stage in the optimization process, so that a problem of multicollinearity can be avoided, and a target neural network with better performance can be built based on an optimized structuring element.

Optionally, the plurality of structuring elements in step 1001 may include a first-type structuring element.

The first-type construction unit is a construction unit whose quantity (which may specifically be a quantity of channels) and size of an input feature map are respectively the same as a quantity and a size of an output feature map.

For example, input of a first-type construction unit is a feature map with a size of C×D1×D2 (C is a quantity of channels, and D1 and D2 are a width and a height respectively), and a size of an output feature map processed by the first-type construction unit is still C×D1×D2.

The first-type construction unit may specifically be a normal cell (normal cell).

Optionally, the plurality of structuring elements in step 1001 include a second-type structuring element.

A resolution of an output feature map of the second-type construction unit is 1/M of an input feature map, a quantity of output feature maps of the second-type construction unit is M times a quantity of input feature maps, and M is a positive integer greater than 1.

M may usually be 2, 4, 6, 8, or the like.

For example, input of a second-type construction unit is a feature map with a size of C×D1×D2 (C is a quantity of channels, D1 and D2 are a width and a height respectively, and a product of C1 and C2 may represent a resolution of the feature map), and a size of a feature map processed by the second-type construction unit is

$$4 C \times ( \frac{1}{2} D 1 \times \frac{1}{2} D 2 ) .$$

The second-type construction unit may specifically be a reduction cell (reduction cell).

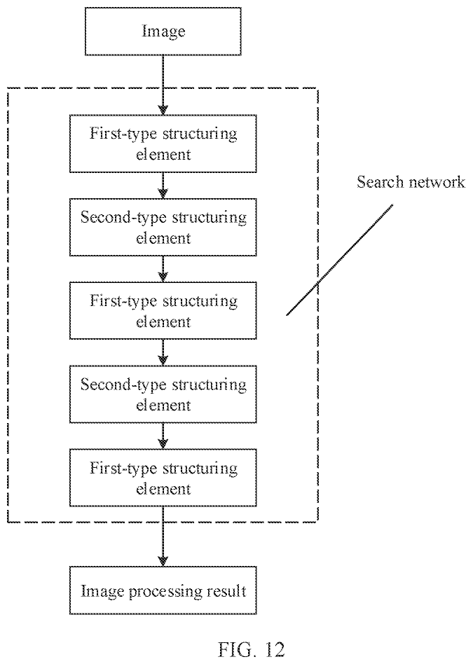

Both the initial neural architecture at the first stage and the initial neural architecture at the second stage may be referred to as a search network, and the search network may be stacked up by using a first structuring element and a second structuring element. The following describes in detail a structure of the search network with reference to FIG. 12.

When the search network includes the first-type construction unit and the second-type construction unit, an architecture of the search network may be shown in FIG. 12.

As shown in FIG. 12, the search network is formed by sequentially superimposing five construction units, where the first and the last construction units in the search network are first-type construction units, and a second-type construction unit is located between every two first-type construction units.

The first construction unit in the search network in FIG. 12 can process an input image. After processing the image, the first-type construction unit inputs a processed feature map to the second-type construction unit for processing, and the feature map is sequentially transmitted backwards, until the last first-type construction unit in the search network outputs a feature map.

Optionally, the method shown in FIG. 7 further includes: performing clustering on a plurality of alternative operators in the search space, to obtain the plurality of groups of alternative operators.

The clustering on a plurality of alternative operators in the search space may be classifying the plurality of alternative operators in the search space into different types, and each type of alternative operators form one group of alternative operators.

Optionally, the performing clustering on a plurality of alternative operators in the search space, to obtain the plurality of groups of alternative operators includes: performing clustering on the plurality of alternative operators in the search space, to obtain correlation between the plurality of alternative operators in the search space; and grouping the plurality of alternative operators in the search space based on the correlation between the plurality of alternative operators in the search space, to obtain the plurality of groups of alternative operators.

The correlation may be linear correlation, where the linear correlation may be represented as a degree of linear correlation (which may be a value from 0 to 1), and a higher value of a degree of linear correlation between two alternative operators indicates a closer relationship between the two alternative operators.

For example, through clustering analysis, a degree of linear correlation between 3×3 max pooling and 3×3 average pooling is 0.9. Then, correlation between 3×3 max pooling and 3×3 average pooling can be considered as relatively high, and 3×3 max pooling and 3×3 average pooling may be classified into one group.

Through clustering, the plurality of alternative operators in the search space can be classified into the plurality of groups of alternative operators, thereby facilitating subsequent optimization in a process of neural network search.

Optionally, the plurality of groups of alternative operators in the search space in step 1001 include:

a first group of alternative operators, including 3×3 max pooling and 3×3 average pooling;

a second group of alternative operators, including a skip connection;

a third group of alternative operators, including 3×3 separable convolutions and 5×5 separable convolutions; and

a fourth group of alternative operators, including 3×3 dilated separable convolutions and 5×5 dilated separable convolutions.

Optionally, the method shown in FIG. 7 further includes: selecting one operator front each of the plurality of groups of alternative operators, to obtain the plurality of alternative operators corresponding to each edge of each structuring element in the initial neural architecture at the first stage.

For example, for the initial neural architecture at the first stage in step 1002, a plurality of alternative operators corresponding to each edge of each structuring element may include 3×3 max pooling, a skip connection, 3×3 separable convolutions, and 3×3 dilated separable convolutions.

Optionally, the method shown in FIG. 7 further includes: determining an operator with a largest weight on each edge of each structuring element in the initial neural architecture at the first stage; and determining a mixed operator including all alternative operators in a group of alternative operators in which there is an operator with a largest weight on a j^{th} edge of an i^{th} structuring element in the initial neural architecture at the first stage as alternative operators corresponding to the j^{th} edge of the i^{th} structuring element in the initial neural architecture at the second stage.

For example, for the optimized initial neural architecture at the first stage, when an operator with a largest weight on a j^{th} edge of an i^{th} structuring element is 3×3 max pooling, for the optimized initial neural architecture at the second stage, an alternative operator corresponding to the j^{th} edge of the i^{th} structuring element is a mixed operator including 3×3 max pooling and 3×3 average pooling.

In addition, in a process of optimizing the initial neural architecture at the second stage, respective weights of 3×3 max pooling and 3×3 average pooling on the j^{th} edge of the i^{th} structuring element in the initial neural architecture at the second stage are determined and then an operator with a largest weight is selected as an operator on the j^{th} edge of the i^{th} structuring element.

Optionally, the method shown in FIG. 7 further includes that the optimizing the initial neural architecture at the first stage to be convergent, to obtain optimized structuring elements includes: separately optimizing, by using same training data, a network architecture parameter and a network model parameter that are of a structuring element in the initial neural architecture at the first stage to be convergent, to obtain the optimized initial neural architecture at the first stage; and/or the optimizing the initial neural architecture at the second stage to be convergent, to obtain optimized structuring elements includes: separately optimizing, by using same training data, a network architecture parameter and a network model parameter that are of a structuring element in the initial neural architecture at the second stage to be convergent, to obtain the optimized structuring elements.

A network architecture parameter and a network model parameter are optimized by using same training data. Compared with conventional two-layer optimization, a neural network with better performance can be obtained through searching with a same amount of training data.

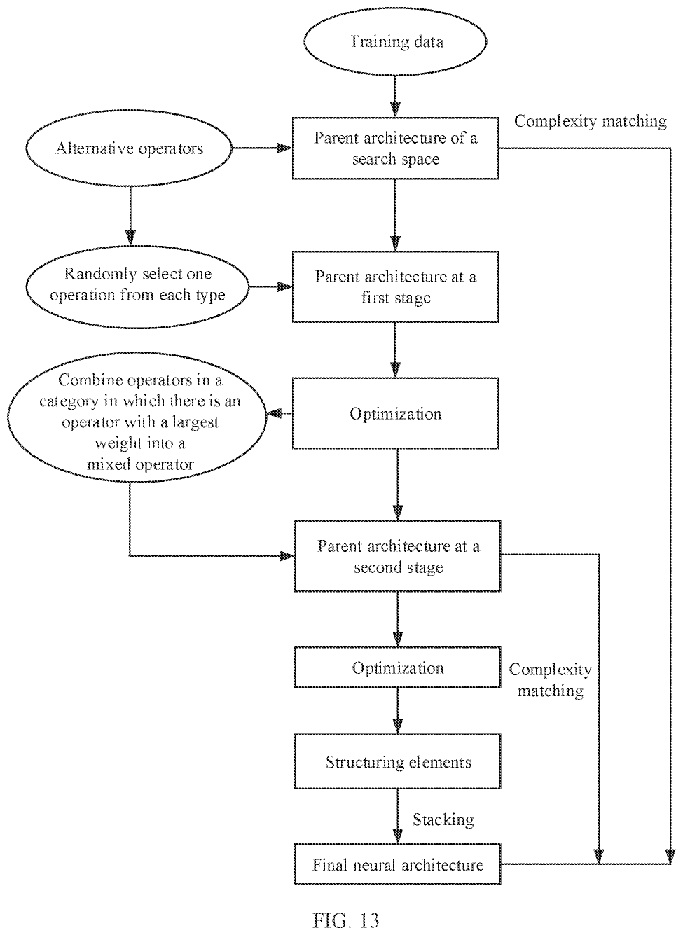

The following describes in detail a neural architecture search method in an embodiment of this application with reference to FIG. 13.

FIG. 13 is a schematic flowchart of a neural architecture search method according to an embodiment of this application; and the method shown in FIG. 13 may be performed by a neural architecture search apparatus in the embodiments of this application (where for example, the method shown in FIG. 13 may be performed by a neural architecture search apparatus shown in FIG. 16).

The method shown in FIG. 13 includes step 2001 to step 2013. The following describes these steps in detail.

2001: Obtain training data.

In step 2001, the training data may be downloaded from a network or manually collected. The training data may be specifically a training image. After the training image is obtained, the training image may be pre-processed based on a target task to be processed for a neural network obtained through searching. The pre-processing may include denoting image categories, image denoising, image size adjustment, data augmentation, and the like. In addition, the training data may further be split into a training set and a test set based on requirements.

2002: Determine a parent architecture of a search space based on an alternative operator.

The parent architecture of the search space is equivalent to an initial neural architecture built by using a plurality of structuring elements.

Before step 2002, the search space may be determined first. Specifically, the continuous search space based on the structuring elements is designed based on a final application scenario of a neural architecture (for example, an image size and an image category in an image classification task).

The search space may include a plurality of groups of alternative operators, and may specifically include the first group of alternative operators, the second group of alternative operators, the third group of alternative operators, and the fourth group of alternative operators that are described above.

2003: Select one operation from each category of alternative operators, to obtain a parent architecture at a first stage.

In step 2003, on the basis of the parent architecture of the search space, one operation is selected from each group of alternative operators, to obtain the parent architecture at the first stage.

The parent architecture at the first stage is equivalent to the initial neural architecture at the first stage described above.

2004: Optimize the parent architecture at the first stage.

When the parent architecture at the first stage is optimized, a degree of complexity may be matched with that of a final neural architecture, so that the parent architecture at the first stage and the final neural architecture match each other as much as possible in terms of degrees of complexity.

For a process in which the parent architecture at the first stage is optimized in step 2001, refer to a process in which the initial neural architecture at the first stage is optimized in step 1003.

2005: Combine all operators in a group in which there is an operator with a largest weight into a mixed operator, to obtain a parent architecture at a second stage.

The parent architecture at the second stage is equivalent to the initial neural architecture at the second stage described above.

2005: Optimize the parent architecture at the second stage, to obtain optimized structuring elements.

When the parent architecture at the second stage is optimized, a degree of complexity may be matched with that of a final neural architecture, so that the parent architecture at the second stage and the final neural architecture match each other as much as possible in terms of degrees of complexity.

For a process in which the parent architecture at the second stage is optimized in step 2005, refer to a process in which the initial neural architecture at the second stage is optimized in step 1005.

Stack the optimized structuring elements to obtain a final neural architecture.

When the conventional DARTS solution is used for neural network search, double-layer optimization is performed on a network structure parameter and a network model parameter that are in structuring elements. Specifically, training data is divided into two parts in the conventional DARTS solution, where one part of the training data is used for optimization of a network architecture parameter in a structuring element in a search network, and the other part of the training data is used for optimization of a network model parameter in the structuring element in the search network. There is no high enough utilization of the training data, and a neural network finally obtained through searching has limited performance.

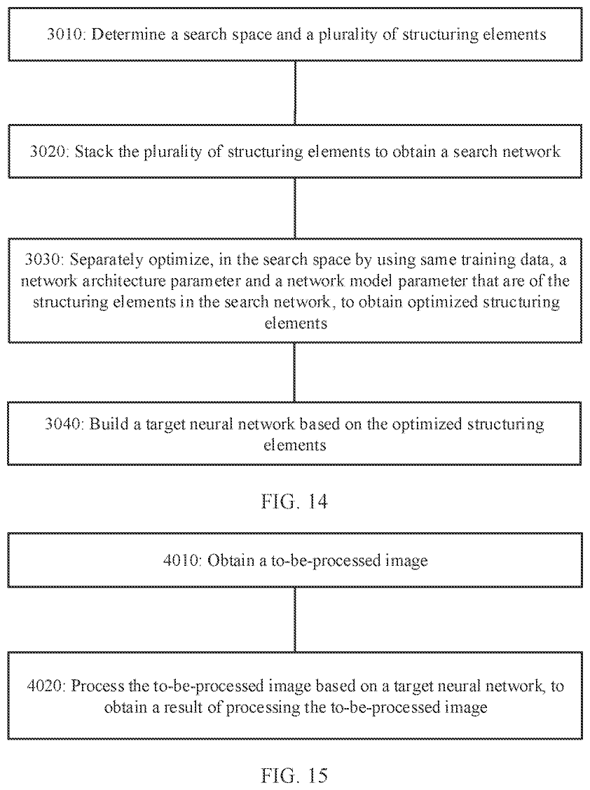

In view of the foregoing problem, this application provides a solution of single-layer optimization in which a network structure parameter and a network model parameter that are in structuring elements are optimized by using same training data, to improve utilization of the training data. Compared with two-layer optimization in the conventional DARTS solution, a neural network with better performance can be obtained through searching with a same amount of training data. The following describes in detail the solution of single-layer optimization with reference to FIG. 14.

FIG. 14 is a schematic flowchart of a neural architecture search method according to an embodiment of this application; and the method shown in FIG. 14 may be performed by a neural architecture search apparatus in the embodiments of this application (where for example, the method shown in FIG. 14 may be performed by a neural architecture search apparatus shown in FIG. 16). The method shown in FIG. 14 includes step 3010 to step 3040. The following describes these steps in detail.

3010: Determine a search space and a plurality of construction units.

Following operations may be included in the search space in step 2001:

3×3 max pooling;

3×3 average pooling;

a skip connection;

3×3 separable convolutions;

5×5 separable convolutions;

3×3 dilated separable convolutions; and

5×5 dilated separable convolutions.

It should be understood that, alternative operators in the search space in step 3010 may alternatively be divided into a plurality of groups. Specifically, the search space in step 3010 may include the first group of alternative operators, the second group of alternative operators, the third group of alternative operators, and the fourth group of alternative operators that are described above.

3020: Superimpose the plurality of construction units to obtain the search network.

3030: Separately optimize, in the search space by using same training data, a network architecture parameter and a network model parameter that are of the structuring elements in the search network, to obtain optimized structuring elements.

In step 3030, when the network architecture parameter and the network model parameter that are of the structuring elements in the search network are separately optimized to obtain the optimized structuring elements, the optimization may be specifically performed at two stages according to a manner in steps 1002 to 1005 of the method shown in FIG. 7 (where in this case, the search space in step 2001 includes a plurality of groups of alternative operators), to obtain the optimized structuring elements (for a specific process, refer to related content of steps 1002 to 1005, and details are not provided herein again).

3040: Establish the target neural network based on the optimized construction units.

Each of the plurality of structuring elements is a network structure that is between a plurality of nodes and that is obtained by connecting basic operators of a neural network.

In this application, a network architecture parameter and a network model parameter are optimized by using same training data. Compared with conventional two-layer optimization, a neural network with better performance can be obtained through searching with a same amount of training data.

Optionally, that a network architecture parameter and a network model parameter that are of the structuring elements in the search network are separately optimized in the search space by using same training data, to obtain optimized structuring elements in step 3030 includes:

determining an optimized network architecture parameter and an optimized. network model parameter of the structuring elements in the search network based on same training data and by using formula (2) and formula (3).

$$\begin{matrix}{α}_{t} = {α}_{t - 1} - {η}_{t} * {\partial }_{α} {L}_{train} ( {w}_{t - 1 ,} {α}_{t - 1} ) & ( 2 ) \\ {w}_{t} = {w}_{t - 1} - {δ}_{t} * {\partial }_{w} {L}_{train} ( {w}_{t - 1 ,} {α}_{t - 1} ) & ( 3 )\end{matrix}$$

In formula (2) and formula (3), meanings of parameters are specifically as follows:

αₜ and wₜ respectively represent a network architecture parameter and a network model parameter that are optimized at a t^{th} step performed on the structuring elements in the search network;

αₜ₋₁ and wₜ₋₁ respectively represent a network architecture parameter and a network model parameter that are optimized at a (t−1)^{th}step performed on the structuring elements in the search network;

ηₜ and δₜ respectively represent learning rates of the network architecture parameter and the network model parameter that are optimized at the t^{th} step performed on the structuring elements in the search network; and

Lₜᵣₐᵢₙ(wₜ₋₁,αₜ₋₁) represents a value of a loss function of a test set during optimization at the t^{th}step, ∂_{α}Lₜᵣₐᵢₙ(wₜ₋₁,αₜ₋₁) represents a gradient for α of the loss function in the test set during optimization at the t^{th} step, and ∂_{w}Lₜᵣₐᵢₙ(wₜ₋₁,αₜ₋₁) represents a gradient for w of the loss function in the test set during optimization at the t^{th} step.

It should be understood that, the network architecture parameter a represents a weight coefficient of each operator, and a value of a indicates importance of the corresponding operator; and w represents a set of all other parameters in the architecture, including a parameter in convolution, a parameter at a prediction layer, and the like.

Through analysis, a problem is found in neural architecture search by using the conventional DARTS solution, that is, data complexity does not match expressiveness of a proxy parent network of a search space. Specifically, due to limitations of some factors (for example, a limitation of a memory size), there is a great gap between a depth of a parent architecture stacked during searching in the DARTS solution and a depth of a finally built neural architecture.

For example, in DARTS searching, a parent search structure stacked by using eight structuring elements is used, but a finally built neural architecture is stacked by using 20 structuring elements. Expressiveness and optimization difficulty of these neural networks with two depths are highly different. For a small architecture with only eight structuring elements, a search algorithm is prone to select more complex operators to express data features, but it is not necessary for a large architecture with 20 structuring elements that is actually used, to use too many complex operators, which is easy to cause a problem such as difficult optimization, thereby causing limited performance of the finally built neural network.

Based on this, this application provides a new neural architecture search solution. In this solution, degrees of complexity of a parent search architecture and a finally built neural network match each other during searching.

Specifically, compared with the original DARTS in which each mixed operator includes seven alternative operators, in this solution, each mixed operator at a first stage has four alternative operators, and each mixed operator at a second stage has two alternative operators. In this manner, a quantity of cells at the first stage may be increased to 14 structuring elements, and a quantity of cells at the second stage may be increased to 20 structuring elements. This solves the problem that expressiveness of a proxy parent network of a search space does not match expressiveness of a final training architecture.

In addition, to lower optimization difficulty, when the final architecture with 20 structuring elements is used, an annularity tower (annularity tower) is used at a position at which the 14 structuring elements are located and is connected to an end. In this way, optimization difficulty of this architecture is equivalent to optimization difficulty of a network architecture with a depth of 14 structuring elements, thereby lowering optimization difficulty.

To verify effectiveness of the foregoing solution, a gradient confusion (gradient confusion) indicator for measuring network optimization complexity is calculated. It is found that, when 14 structuring elements are used at the first stage and 20 structuring elements are used at the second stage, optimization complexity of the finally built neural architecture can be matched.

The following describes effectiveness of the neural architecture search method in the embodiments of this application with reference to specific testing results.

In this part, the effectiveness of the neural architecture search method in the embodiments of this application is verified by using a specific example of an image classification task.

During testing, a first experiment is carried out on two public data sets (CIFAR-10 and CIFAR-100), and each experiment includes 50,000 training images and 10,000 testing images.

At a stage of neural architecture search, a training set is randomly divided into two subsets, where one subset includes 45,000 images and is used for training a and w at the same time, and the other subset includes 5,000 images and is used as a training set to select, in a process of training, an architecture parameter a capable of achieving highest verification precision. At a stage of estimating performance of the neural architecture, standard training/testing split (testing split) is used.

At the first stage of neural architecture search, an optional operation O includes a skip connection operation; 3×3 max pooling; 3×3 separable convolutions; 3×3 dilated separable convolutions; and zero setting.

In the method of single-layer optimization, one proxy parent network (proxy parent network) stacked up by using 14 units is trained for optimization for 1,000 epochs (epochs). After the proxy parent network is convergent, an optimal operation group is activated based on α.

At the second stage, a mixed operation ob(i;j) is replaced to be with a weighted sum of all operations in the activated group at the first stage. Then, level-one optimization for 100 epochs is performed for training a proxy parent network stacked up by using 20 structuring elements.

TABLE 4

| | Test | Parameter | Search | |
|---|---|---|---|---|
| Solution | error | count (M) | costs | Search method |
| Conventional | 2.55 | 2.8 | 3150 | Evolution-based |
| solution 1 | | | | search |
| Conventional | 2.08 | 5.7 | 4 | Gradient-based |
| solution 2 | | | | search |
| Conventional | 2.89 | 4.6 | 0.5 | Reinforcement |
| solution 3 | | | | learning |
| Conventional | — | 3.3 | 4 | Gradient-based |
| solution 4 | | | | search |
| Solution of this | 2.45 | 3.6 | 1 | Gradient-based |
| application | | | | search |

After a final neural architecture is obtained by stacking the 20 units, a conventional method exactly the same as DARTS may be used for training, and a testing result of a trained neural architecture on the data set CIFAR-10 is shown in Table 4.

Table 4 shows test errors, a parameter count, and search costs of neural architectures obtained through searching by using different neural architecture search solutions. A meaning of each solution is specifically as follows:

A conventional solution 1 may be represented as AmoebaNet-B, and the solution is specifically regularization evolution of image classifier structure search (cited from Sirui Xie, Hehui Zheng, Chunxiao Liu, and Liang Lin. Snas: stochastic neural architecture search. arXiv preprint arXiv: 1812.09926, 2018).

A conventional solution 2 may be represented as ProxylessNAS, and the solution is specifically to perform direct neural architecture search on a target task and hardware cited from Han Cai, Ligeng Zhu, and Song Han. Proxylessnas: Direct neural architecture search on target task and hardware. arXiv preprint arXiv: 1812.00332, 2018).

A conventional solution 3 may be represented as ENAS, and the solution is specifically to perform efficient neural architecture search via parameter sharing (cited from Hieu Pham, Melody Y Guan, Barret Zoph, Quoc V Le, and Jeff Dean. Efficient neural architecture search via parameter sharing, arXiv preprint arXiv: 1802.03268, 2018).

A conventional solution 4 may be represented as DARTS, and the solution is specifically differentiable architecture search (cited from Hanxiao Liu, Karen Simonyan, and Miming Yang. Darts: Differentiable architecture search. arXiv preprint arXiv: 1806.09055, 2018).

The solution in this application may be represented as iDARTS. Herein, iDARTS may represent the neural architecture search method shown in FIG. 7, and a neural architecture obtained through searching uses an exactly same conventional method as the conventional DARTS solution for training.

It can be learned from Table 4 that compared with the solution AmoebaNet-B and the solution ENAS, a neural network obtained in the solution in this application has fewer test errors and higher precision. Although the solution ProxylessNAS has higher precision than that achieved in the solution in this application, the solution ProxylessNAS requires more memory.

In the embodiments of this application, in neural network search, the method shown in FIG. 7 may be used for searching at two stages, or the method shown in FIG. 14 may be used for single-layer optimization. The following describes testing results of neural architectures obtained when search is performed at two stages and single-layer/double-layer optimization is performed during neural architecture search in the embodiments of this application.

TABLE 5

| | CIFAR-10 | | CIFAR-100 | |
|---|---|---|---|---|
| | Double-layer | Single-layer | Double-layer | Single-layer |
| Solution | optimization | optimization | optimization | optimization |
| Original | 2.97 ± 0.32 | 2.74 ± 0.12 | 19.45 ± 1.56 | 16.93 ± 0.89 |
| settings | | | | |
| Two-stage | 2.82 ± 0.26 | 2.68 ± 0.10 | 18.25 ± 1.19 | 16.68 ± 0.65 |
| search | | | | |

As shown in Table 5, original settings mean that the conventional DARTS solution is used for neural architecture search, and two-stage search means that the method shown in FIG. 7 is used for neural architecture search. Double-layer optimization means that a network structure parameter and a network model parameter that are in structuring elements of a search network are optimized separately by using different training data, and single-layer optimization means that a network structure parameter and a network model parameter that are in structuring elements of a search network are optimized separately by using same training data (for details, refer to the method shown in FIG. 14). CIFAR-10 and CIFAR-100 represent different test sets. Numbers in the table represent test errors (test error) and variances of the test errors.

It can be learned from Table 5 that regardless of the search manner, test errors after single-layer optimization are fewer than test errors after double-layer optimization, and variances are also reduced. Therefore, single-layer optimization may be used to reduce test errors of a finally built neural architecture, can improve testing precision of the finally obtained neural architecture, and can also improve stability of the finally obtained neural architecture.

For another example, it can be learned from Table 5 that a two-stage search solution may also be used to improve testing precision of the finally obtained neural architecture and stability of the finally obtained neural architecture.

FIG. 15 is a schematic flowchart of an image processing method according to an embodiment of this application. It should be understood that, restrictions, explanations, and extensions of a related process of obtaining a target neural network in the foregoing are also applicable to the target neural network in the method shown in FIG. 15. Repeated descriptions are properly omitted in description of the method shown in FIG. 15 below. The method shown in FIG. 15 includes the following steps.

4010: Obtain a to-be-processed image.

4020: Process the to-be-processed image based on the target neural network, to obtain a result of processing the to-be-processed image.

The target neural network in step 4020 may be a neural network obtained through searching (structuring) according to the neural architecture search method in the embodiments of this application. Specifically, the target neural network in step 4020 may be the neural architecture obtained according to the methods shown in FIG. 7, FIG. 13, and FIG. 14.

Because a target neural network with better performance can be structured by using the neural architecture search method in the embodiments of this application, when the target neural network is used to process the to-be-processed image, a more accurate image processing result can be obtained.

Processing the to-be-processed image may mean recognizing, classifying, detecting the to-be-processed image, and the like.

The image processing method shown in FIG. 15 may be specifically used for image classification, semantic segmentation, face recognition, and another specific scenario. The following describes these specific applications.

Image classification:

When the method shown in FIG. 15 is used for an image classification scenario, first a to-be-processed image needs to be obtained, and then features of the to-be-processed image are extracted based on the target neural network, to obtain the features of the to-be-processed image. Then, the to-be-processed image is classified based on the features of the to-be-processed image, to obtain a result of classifying the to-be-processed image.

Because a target neural network with better performance can be structured by using the neural architecture search method in the embodiments of this application, using the target neural network to classify the to-be-processed image can obtain a better and more accurate image classification result.

Semantic segmentation in an autonomous driving scenario:

When the method shown in FIG. 15 is used for a semantic segmentation scenario in an autonomous driving system, first a picture of a lane needs to be obtained, and then convolution is performed on the picture of the lane based on the target neural network, to obtain a plurality of convolutional feature maps of the picture of the lane. Finally, deconvolution is performed on the plurality of convolutional feature maps of the picture of the lane based on the target neural network, to obtain a result of semantically segmenting the picture of the lane,

Because a target neural network with better performance can be structured by using the neural architecture search method in the embodiments of this application, using the target neural network to semantically segment the picture of the lane can obtain a better semantic segmentation result.

Face recognition:

When the method shown in FIG. 15 is used for a semantic segmentation scenario in an autonomous driving system, a picture of a lane needs to be obtained first, and then convolution is performed on the face image based on the target neural network, to obtain a convolutional feature map of the face image. Finally, the convolutional feature map of the face image is compared with a convolutional feature map of an identity card image, to obtain a result of verifying the face image.

Because a target neural network with better performance can be structured by using the neural architecture search method in the embodiments of this application, using the target neural network to recognize the face image can obtain a better recognition effect.

FIG. 16 is a schematic diagram of a hardware architecture of a neural architecture search apparatus according to an embodiment of this application. The neural architecture search apparatus 3000 shown in FIG. 16 may perform various steps of the neural architecture search method in the embodiments of this application. Specifically, the neural architecture search apparatus 3000 may perform various steps of the methods shown in FIG. 7, FIG. 13, and FIG. 14 described above.

The neural architecture search apparatus 3000 shown in FIG. 16 (the apparatus 3000 may specifically be a computer device) includes a memory 3001, a processor 3002, a communication interface 3003, and a bus 3004. The memory 3001, the processor 3002, and the communication interface 3003 are communicatively connected to each other by using the bus 3004.

The memory 3001 may be a read-only memory (read-only memory, ROM), a static storage device, a dynamic storage device, or a random access memory (random access memory, RAM). The memory 3001 may store a program. When executing the program stored in the memory 3001, the processor 3002 is configured to perform steps of the neural architecture search method in this embodiment of this application.

The processor 3002 may be a general-purpose central processing unit (central processing unit, CPU), a microprocessor, an application-specific integrated circuit (application-specific integrated circuit, ASIC), a graphics processing unit (graphics processing unit, GPU), or one or more integrated circuits, and is configured to execute a related program, to implement the neural architecture search method in the method embodiments of this application.

The processor 3002 may alternatively be an integrated circuit chip and has a signal processing capability. In an implementation process, the steps of the neural architecture search method in this application may be completed by using a hardware integrated logic circuit or instructions in a form of software in the processor 3002.

The processor 3002 may alternatively be a general-purpose processor, a digital signal processor (digital signal processor, DSP), an application-specific integrated circuit (ASIC), a field programmable gate array (field programmable gate array, FPGA) or another programmable logic device, a discrete gate or transistor logic device, or a discrete hardware component. The methods, the steps, and logic block diagrams that are disclosed in the embodiments of this application may be implemented or performed. The general purpose processor may be a microprocessor, or the processor may be any conventional processor or the like. Steps of the methods disclosed with reference to the embodiments of this application may be directly executed and accomplished by using a hardware decoding processor, or may be executed and accomplished by using a combination of hardware and software modules in a decoding processor. The software module may be located in a mature storage medium in the art, such as a random access memory, a flash memory, a read-only memory, a programmable read-only memory, an electrically erasable programmable memory, or a register. The storage medium is located in the memory 3001. The processor 3002 reads information in the memory 3001, and completes, in combination with hardware of the processor 3002, a function that needs to be executed by a unit included in the neural architecture search apparatus 3000, or performs the neural architecture search method in the method embodiments of this application.

The communication interface 3003 uses a transceiver apparatus, for example but not for limitation, a transceiver, to implement communication between the apparatus 3000 and another device or a communication network. For example, information about a to-be-established neural network and training data required in a process of establishing a neural network may be obtained through the communication interface 3003.

The bus 3004 may include a path for transmitting information between the components (for example, the memory 3001, the processor 3002, and the communication interface 3003) of the apparatus 3000.

FIG. 17 is a schematic diagram of a hardware architecture of an image processing apparatus according to an embodiment of this application.

The image processing apparatus 4000 shown in FIG. 17 may perform various steps of the image processing method in the embodiments of this application. Specifically, the image processing apparatus 4000 may perform various steps of the method shown in FIG. 15 described above.

The image processing apparatus 4000 shown in FIG. 17 includes a memory 4001, a processor 4002, a communication interface 4003, and a bus 4004. The memory 4001, the processor 4002, and the communication interface 4003 are communicatively connected to each other by using the bus 4004.

The memory 4001 may be a ROM, a static storage device, or a RAM. The memory 4001 may store a program. When executing the program stored in the memory 4001, the processor 4002 and the communication interface 4003 are configured to perform steps of the image processing method in this embodiment of this application.

The processor 4002 may be a general-purpose CPU, a microprocessor, an ASIC, a GPU, or one or more integrated circuits, and is configured to execute a related program, to implement a function that needs to be executed by a unit in the image processing apparatus in this embodiment of this application, or perform the image processing method in the method embodiments of this application.

The processor 4002 may alternatively be an integrated circuit chip and has a signal processing capability. In an implementation process, the steps of the image processing method in this application may be completed by using a hardware integrated logic circuit or instructions in a form of software in the processor 4002.

The foregoing processor 4002 may alternatively be a general-purpose processor, a DSP, an ASIC, an FPGA or another programmable logic device, a discrete gate or transistor logic device, or a discrete hardware component. The methods, the steps, and logic block diagrams that are disclosed in the embodiments of this application may be implemented or performed. The general purpose processor may be a microprocessor, or the processor may be any conventional processor or the like. Steps of the methods disclosed with reference to the embodiments of this application may be directly executed and accomplished by using a hardware decoding processor, or may be executed and accomplished by using a combination of hardware and software modules in a decoding processor. The software module may be located in a mature storage medium in the art, such as a random access memory, a flash memory, a read-only memory, a programmable read-only memory, an electrically erasable programmable memory, or a register. The storage medium is located in the memory 4001. The processor 4002 reads information in the memory 4001, and completes, in combination with hardware of the processor 4002, a function that needs to be executed by a unit included in the image processing apparatus in this embodiment of this application, or performs the image processing method in the method embodiments of this application.

The communication interface 4003 uses a transceiver apparatus, for example but not for limitation, a transceiver, to implement communication between the apparatus 4000 and another device or a communication network. For example, a to-be-processed image may be obtained through the communication interface 4003.

The bus 4004 may include a path for transmitting information between the components (for example, the memory 4001, the processor 4002, and the communication interface 4003) of the apparatus 4000.

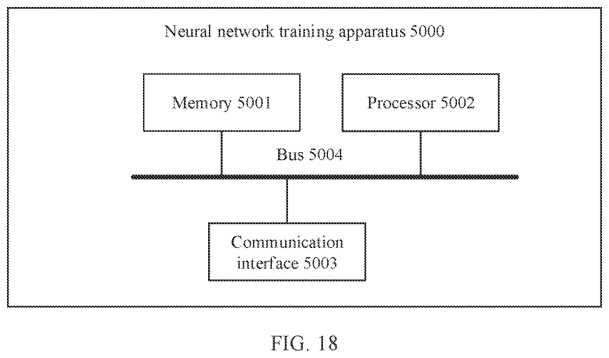

FIG. 18 is a schematic diagram of a hardware architecture of a neural network training apparatus according to an embodiment of this application. Similar to the foregoing apparatus 3000 and 4000, a neural network training apparatus 5000 shown in FIG. 18 includes a memory 5001, a processor 5002, a communication interface 5003, and a bus 5004. The memory 5001, the processor 5002. and the communication interface 5003 are communicatively connected to each other by using the bus 5004.

After a neural network is established by using the neural architecture search apparatus shown in FIG. 16, the neural network may be trained by using the neural network training apparatus 5000 shown in FIG. 18, and a trained neural network may be used to perform the image processing method in this embodiment of this application.

Specifically, the apparatus shown in FIG. 18 may obtain training data and a to-be-trained neural network from the outside through the communication interface 5003, and then the processor trains the to-be-trained neural network based on the training data.

It should be noted that, although only the memory, the processor, and the communication interface are shown in each of the apparatus 3000, the apparatus 4000, and the apparatus 5000, in a specific implementation process, a person skilled in the art should understand that the apparatus 3000, the apparatus 4000, and the apparatus 5000 each may further include another component necessary for normal running. In addition, based on a specific requirement, a person skilled in the art should understand that the apparatus 3000, the apparatus 4000, and the apparatus 5000 each may further include a hardware component for implementing another additional function. In addition, a person skilled in the art should understand that the apparatus 3000, the apparatus 4000, and the apparatus 5000 each may include only components necessary for implementing the embodiments of this application, but not necessarily include all the components shown in FIG. 16, FIG. 17, and FIG. 18.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the apparatus embodiments described above are only examples. For example, division into the units is only logical function division, and may be other division during actual implementation. For example, a plurality of units or components may be combined or integrated into another system, or some features may be ignored or may not be performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of this application. The foregoing storage medium includes any medium that can store program code, such as a USB flash drive, a removable hard disk, a read-only memory (Read-Only Memory, ROM), a random access memory (Random Access Memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A neural architecture search method, comprising:
determining a search space and a plurality of structuring elements, wherein the search space comprises a plurality of groups of alternative operators, operators in each group of alternative operators are of a same type, each of the plurality of structuring elements is a network structure that is between a plurality of nodes and that is obtained by connecting basic operators of a neural network, and the nodes of each of the plurality of structuring elements are connected to form an edge;
stacking the plurality of structuring elements to obtain an initial neural architecture at a first stage, wherein each edge of each structuring element in the initial neural architecture at the first stage corresponds to a plurality of alternative operators, and each of the plurality of alternative operators corresponds to one group in the plurality of groups of alternative operators;
optimizing the initial neural architecture at the first stage to be convergent, to obtain an optimized initial neural architecture at the first stage;
obtaining the initial neural architecture at a second stage, wherein a mixed operator corresponding to a j^{th} edge of an i^{th} structuring element in the initial neural architecture at the second stage comprises all operators in a k^{th} group of alternative operators in the optimized initial neural architecture at the first stage, the k^{th} group of alternative operators is a group of alternative operators comprising an operator with a largest weight in a plurality of alternative operators corresponding to the j^{th} edge of the i^{th} structuring element in the optimized initial neural architecture at the first stage, and i, j, and k are all positive integers;
optimizing the initial neural architecture at the second stage to be convergent, to obtain optimized structuring elements; and
building a target neural network based on the optimized structuring elements.

2. The search method according to claim 1, wherein the search method further comprises:
performing clustering on a plurality of alternative operators in the search space, to obtain the plurality of groups of alternative operators.

3. The search method according to claim 1, wherein the search method further comprises:
selecting one operator from each of the plurality of groups of alternative operators, to obtain the plurality of alternative operators corresponding to each edge of each structuring element in the initial neural architecture at the first stage.

4. The search method according to claim 3, wherein the search method further comprises:
determining an operator with a largest weight on each edge of each structuring element in the initial neural architecture at the first stage; and
determining a mixed operator comprising all alternative operators in a group of alternative operators in which there is an operator with a largest weight on a j^{th} edge of an i^{th} structuring element in the initial neural architecture at the optimized first stage as alternative operators corresponding to the j^{th} edge of the i^{th} structuring element in the initial neural architecture at the second stage.

5. The search method according to claim 1, wherein the plurality of groups of alternative operators comprise:
a first group of alternative operators, comprising 3×3 max pooling and 3×3 average pooling;
a second group of alternative operators, comprising a skip connection;
a third group of alternative operators, comprising 3×3 separable convolutions and 5×5 separable convolutions; and
a fourth group of alternative operators, comprising 3×3 dilated separable convolutions and 5×5 dilated separable convolutions.

6. The search method according to claim 1, wherein the optimizing the initial neural architecture at the first stage to be convergent, to obtain optimized structuring elements comprises:
separately optimizing, by using same training data, a network architecture parameter and a network model parameter that are of a structuring element in the initial neural architecture at the first stage to be convergent, to obtain the optimized initial neural architecture at the first stage; and/or
the optimizing the initial neural architecture at the second stage to be convergent, to obtain optimized structuring elements comprises:
separately optimizing, by using same training data, a network architecture parameter and a network model parameter that are of a structuring element in the initial neural architecture at the second stage to be convergent, to obtain the optimized structuring elements.

7. A neural architecture search method, comprising:
determining a search space and a plurality of structuring elements, wherein each of the plurality of structuring elements is a network structure that is between a plurality of nodes and that is obtained by connecting basic operators of a neural network;
stacking the plurality of structuring elements to obtain a search network;
separately optimizing, in the search space by using same training data, a network architecture parameter and a network model parameter that are of the structuring elements in the search network, to obtain optimized structuring elements; and
building a target neural network based on the optimized structuring elements.

8. The search method according to claim 7, wherein the separately optimizing, in the search space by using same training data, a network architecture parameter and a network model parameter that are of the structuring elements in the search network, to obtain optimized structuring elements comprises:
determining an optimized network architecture parameter and an optimized network model parameter of the structuring elements in the search network based on same training data and by using formulas, wherein
$${α}_{t} = {α}_{t - 1} - {η}_{t} * {\partial }_{α} {L}_{train} ( {w}_{t - 1 ,} {α}_{t - 1} ) ; and$$
$${w}_{t} = {w}_{t - 1} - {δ}_{t} * {\partial }_{w} {L}_{train} ( {w}_{t - 1 ,} {α}_{t - 1} ) ,$$
wherein
αᵢ and wᵢ respectively represent a network architecture parameter and a network model parameter that are optimized at a t^{th} step performed on the structuring elements in the search network; αₜ₋₁ and wₜ₋₁ respectively represent a network architecture parameter and a network model parameter that are optimized at a (t−1)^{th}step performed on the structuring elements in the search network; ηₜ and δₜ respectively represent learning rates of the network architecture parameter and the network model parameter that are optimized at the t^{th} step performed on the structuring elements in the search network; Lₜᵣₐᵢₙ(wₜ₋₁, αₜ₋₁) represents a value of a loss function of a test set during optimization at the t^{th} step; ∂_{α}Lₜᵣₐᵢₙ(wₜ₋₁,αₜ₋₁) represents a gradient for α of the loss function in the test set during optimization at the t^{th} step; and ∂_{w}Lₜᵣₐᵢₙ(wₜ₋₁,αₜ₋₁) represents a gradient for w of the loss function in the test set during optimization at the t^{th} step.

9. A neural architecture search apparatus, comprising:
a memory, configured to store a program; and
a processor, configured to execute the program stored in the memory, wherein when the program stored in the memory is executed, the processor is configured to perform the following processes:
determining a search space and a plurality of structuring elements, wherein the search space comprises a plurality of groups of alternative operators, operators in each group of alternative operators are of a same type, each of the plurality of structuring elements is a network structure that is between a plurality of nodes and that is obtained by connecting basic operators of a neural network, and the nodes of each of the plurality of structuring elements are connected to form an edge;
stacking the plurality of structuring elements to obtain an initial neural architecture at a first stage, wherein each edge of each structuring element in the initial neural architecture at the first stage corresponds to a plurality of alternative operators, and each of the plurality of alternative operators corresponds to one group in the plurality of groups of alternative operators;
comprising one alternative operator in each of the plurality of groups of alternative operators;
optimizing the initial neural architecture at the first stage to be convergent, to obtain an optimized initial neural architecture at the first stage;
obtaining the initial neural architecture at a second stage, wherein a mixed operator corresponding to a j^{th} edge of an i^{th} structuring element in the initial neural architecture at the second stage comprises all operators in a k^{th} group of alternative operators in the optimized initial neural architecture at the first stage, the k^{th} group of alternative operators is a group of alternative operators comprising an operator with a largest weight in a plurality of alternative operators corresponding to the j^{th} edge of the i^{th} structuring element in the optimized initial neural architecture at the first stage, and i, j, and k are all positive integers;
optimizing the initial neural architecture at the second stage to be convergent, to obtain optimized structuring elements; and
building a target neural network based on the optimized structuring elements.

10. The neural architecture search apparatus according to claim 9, wherein the processor is further configured to:
perform clustering on a plurality of alternative operators in the search space, to obtain the plurality of groups of alternative operators.

11. The neural architecture search apparatus according to claim 9, wherein the processor is further configured to:
select one operator from each of the plurality of groups of alternative operators, to obtain the plurality of alternative operators corresponding to each edge of each structuring element in the initial neural architecture at the first stage.

12. The neural architecture search apparatus according to claim 11, wherein the processor is further configured to:
determine an operator with a largest weight on each edge of each structuring element in the initial neural architecture at the first stage; and
determine a mixed operator comprising all alternative operators in a group of alternative operators in which there is an operator with a largest weight on a j^{th} edge of an i^{th} structuring element in the initial neural architecture at the first stage as alternative operators corresponding to the j^{th} edge of the i^{th} structuring element in the initial neural architecture at the second stage.

13. The neural architecture search apparatus according to claim 9, wherein the plurality of groups of alternative operators comprise:
a first group of alternative operators, comprising 3×3 max pooling and 3×3 average pooling;
a second group of alternative operators, comprising a skip connection;
a third group of alternative operators, comprising 3×3 separable convolutions and 5×5 separable convolutions; and
a fourth group of alternative operators, comprising 3×3 dilated separable convolutions and 5×5 dilated separable convolutions.

14. The neural architecture search apparatus according to claim 9, wherein the processor is further configured to:
separately optimize, by using same training data, a network architecture parameter and a network model parameter that are of a structuring element in the initial neural architecture at the first stage to be convergent, to obtain the optimized initial neural architecture at the first stage; and/or
the optimizing the initial neural architecture at the second stage to be convergent, to obtain optimized structuring elements comprises:
separately optimizing, by using same training data, a network architecture parameter and a network model parameter that are of a structuring element in the initial neural architecture at the second stage to be convergent, to obtain the optimized structuring elements.

15. A neural architecture search apparatus, comprising:
a memory, configured to store a program; and
a processor, configured to execute the program stored in the memory, wherein when the program stored in the memory is executed, the processor is configured to perform the following processes:
determining a search space and a plurality of structuring elements, wherein each of the plurality of structuring elements is a network structure that is between a plurality of nodes and that is obtained by connecting basic operators of a neural network;
stacking the plurality of structuring elements to obtain a search network;
separately optimizing, in the search space by using same training data, a network architecture parameter and a network model parameter that are of the structuring elements in the search network, to obtain optimized structuring elements; and
building a target neural network based on the optimized structuring elements.

16. The neural architecture search apparatus according to claim 15, wherein the processor is configured to:
determine an optimized network architecture parameter and an optimized network model parameter of the structuring elements in the search network based on same training data and by using formulas, wherein
$${α}_{t} = {α}_{t - 1} - {η}_{t} * {\partial }_{α} {L}_{train} ( {w}_{t - 1 ,} {α}_{t - 1} ) ; and$$
$${w}_{t} = {w}_{t - 1} - {δ}_{t} * {\partial }_{w} {L}_{train} ( {w}_{t - 1 ,} {α}_{t - 1} ) ,$$
wherein
α and wₜ respectively represent a network architecture parameter and a network model parameter that are optimized at a t^{th} step performed on the structuring elements in the search network; αₜ₋₁ and wₜ₋₁ respectively represent a network architecture parameter and a network model parameter that are optimized at a (t−1)^{th} step performed on the structuring elements in the search network; ηₜ and δₜ respectively represent learning rates of the network architecture parameter and the network model parameter that are optimized at the t^{th} step performed on the structuring elements in the search network; Lₜᵣₐᵢₙ(wₜ₋₁,αₜ₋₁) represents a value of a loss function of a test set during optimization at the t^{th} step; ∂_{α}Lₜᵣₐᵢₙ(wₜ₋₁,αₜ₋₁) represents a gradient for α of the loss function in the test set during optimization at the t^{th} step; and ∂_{w}Lₜᵣₐᵢₙ(wₜ₋₁,αₜ₋₁) represents a gradient for w of the loss function in the test set during optimization at the t^{th} step.

17. A computer-readable storage medium, wherein the computer-readable medium stores program code used for device execution, and the program code is used for performing the search method according to claim 1.

18. A chip, wherein the chip comprises a processor and a data interface, and the processor reads, by using the data interface, instructions stored in a memory, to perform the search method according to claim 1.
